(19) United States
(12) Patent Application Publication
(10) Pub. No.: US 2004/0014013 A1
(43) Pub. Date: Jan. 22, 2004

(54) Interface for a presentation system

(75) Inventors: Michael E. Diesel, Saugus, MA (US); Peter J. Isermann, Rossville, KS (US); Richard T. Beck IV, Rossville, KS (US); Shane W. Hill, St. Marys, KS (US); Jeffrey L. Knight, St. Marys, KS (US); Dennis C. Chang, Newmarket, NH (US); David W. Lucas, Rochester, NH (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Telecommunications Research Associates, St. Marys, KS

(21) Appl. No.: 10/287,441

(22) Filed: Nov. 1, 2002

Related U.S. Application Data
(60) Provisional application No. 60/334,714, filed on Nov. 1, 2001.
(60) Provisional application No. 60/400,606, filed on Aug. 1, 2002.

(51) Int. Cl. G09B 19/00

(52) U.S. Cl. 434/118; 434/362; 434/350

(57) ABSTRACT

A computerized learning system implements an electronic learning environment over a communications network. A client system can access an interactive presentation from a server. A delivery system can be used to deliver the interactive presentation from the server viewable by a user for a smooth presentation.

The delivery system can include a pre-loading engine that delivers the interactive presentation to the client system based on a priority scheme. The priority scheme can be determined based on the types of media objects in the interactive presentation.

The interactive presentation can be built in XML based on header tags or tables of a HTML document. The header tags and the tables can define a layout of page assets, time-coding data for displaying the page assets, and an interactive exercise associated with the page.

The interactive presentation can include a progress bar and a table of contents. The table of contents can dynamically synchronizes its assets when a user navigates through the interactive presentation. The interactive presentation can enable a user to navigate through the entire interactive presentation using only one keystroke interaction.

### RELATED APPLICATION

This application claims the benefit of U.S. Provisional application 60/334,714, filed Nov. 1, 2001, and U.S. Provisional application 60/400,606, filed Aug. 1, 2002, the entire teachings of which are incorporated herein by reference.

### BACKGROUND

There are a number of ways to create a simulated learning environment. Traditionally, a simulated learning environment is developed using educational audio and visual content. In the typical scenario, a combination of text, audio, video and animated content are arranged into a presentation and stored in electronic format. This arrangement of content creates a simulated learning environment that is often referred to as electronic learning (e-learning).

Interactive e-learning designs have been developed for the Internet. Internet based e-learning applications or web sites that provide synchronized media content are forced to deliver their content within the constraints of each user's bandwidth resource parameters. While this is not a particular concern for users with high bandwidth network connections, it is a concern for users with low bandwidth network connections.

Consider a web site that delivers dynamic, media rich content. If, for example, synchronized text, and multi-megabyte audio and animated content are delivered to a user with a low bandwidth network connection, the synchronization during playback will not be preserved. In particular, the text content can load before the animated content, thus the synch will be off during playback and the throughput, end-to-end latency and real-time responsiveness will be compromised. As a result, the user will not be able to have the intended multimedia experience.

Different schemes have been developed to preserve the viewing experience of media data over a network connection. One scheme combines media content into a single data file, or object for downloading or streaming. Another scheme combines media content into data packets for streaming. However, these schemes are not suitable for multi-megabyte content and for interactive media. If, for example, a user is viewing one media file which offers links to other media files and the user selects one of the links, there will be a delay before the user is able to actually view the selected media file because it must be downloaded or streamed. As a result, there will be interruptions in the user's interactive and viewing experiences. These interruptions are common to viewing such material over low and high bandwidth network connections.

### SUMMARY

The schemes described above provide limited solutions to the problems described. In particular, one drawback is that they are not versatile, namely because they do not facilitate the transmission of multi-megabyte content. Such problems are more pronounced over low bandwidth communication channels, but high bandwidth alone does not cure the root causes of the problems.

In accordance with a computerized learning system, a system and method can implement an electronic learning environment over a communications network. A database can store a plurality of data objects. The plurality of data objects can include a text data object, a media data object, a markup language data object, and a scripting data object. A content creation station can develop an interactive presentation by selecting an arrangement of the data objects that are stored in the database. A server can store the interactive presentation. A client system can access the interactive presentation from the server. A delivery system can be used to deliver the interactive presentation from the server viewable by a user for a smooth presentation.

A media management module can organize an arrangement of the plurality of data objects stored in the database. A building module can receive the arrangement of the plurality of data objects from the media management module. A database can store the received arrangement. The media management module can process the arrangement into an interactive presentation.

A hyperlinking system can automatically generate hyperlinks between similar data objects in the interactive presentation. The hyperlinking system can include a filter to search for similar attributes of the data objects, a matcher to match the similar attributes of the data objects, and validation logic for eliminating invalid matches. At least one key-field in a database table can be used to classify an attribute associated with the data object. The data object can include a text data object that can be keywords or tags that describe a media object. The filter can search the attributes stored in key-fields in the database, an search the root elements associated with the attributes. The key-fields can include acronyms, primary expansion, secondary expansion, and common user expansion. A pre-defined set of rules can determine invalid matches. The predefined set of rules can include logic for determining data object characteristics including compound words, punctuation, and spacing.

Logic can configure the hyperlinking system to generate a link to a first occurrence of a data object on a page in the interactive presentation. Logic can generate the hyperlinks based on a display protocol defined by the interactive presentation. Validation logic can be used to avoid invalid matches, which result from duplicate keywords. The interactive presentation can include a plurality of pages that have corresponding data objects. A time-coder can indicate a time-code for data objects. The time-coder can define a frame number and anchor position of data object included the interactive presentation. The time-code can manage the synchronization of the display of the data objects.

The delivery system can include a pre-loading engine that delivers the interactive presentation to the client system based on a priority scheme. A navigation can display engine can display pages on the user interface. The priority scheme can be determined based on the types of data objects in the interactive presentation.

In accordance with a computerized learning system, a system and method can implement an electronic learning environment in a distributed computer system. A database can store a plurality of media objects. A content creation station can select an arrangement of the media objects from the database. Each selected arrangement of the media objects can be generated into an interactive presentation that can be stored on a server. A client system can access the interactive presentation from the server. A delivery system can deliver the interactive presentation data to the client system. The delivery system can provide a smooth display of the interactive presentation on a user interface by delivering anticipated page assets to a cache or memory location on the client system. The client system can access the page assets directly from their system without having to wait for the page assets to download.

In accordance with an interface for a presentation system, a method and system can develop an interactive presentation in XML. An XML document can be built based on header tags of a HTML document. The HTML document can be processes specifically based on the header tags. The header tags can define a layout of page assets associated with the XML document. The header tags can also define time-coding data for displaying the page assets of the XML document. The time-coding data can preserve the synchronization of the display of the page assets on a user interface.

Pseudo tags associated with the HTML header tags can be used to define a structure of the XML document. The HTML header tags can determine a beginning and ending of pages, and an arrangement of data objects for display on a user interface. The header tags can define a synchronization scheme for displaying media objects on a user interface based on the header tags. The header tags can define a type of interactive exercise to be displayed in the XML document. The type of interactive exercise can be a dichotomous exercise, a multiple choice exercise, a multiple select exercise, or an ordered list exercise.

There are a number of factors that can determine the type of exercise. One factor can be the type of data stored in a data object of the HTML document. The data objects can be either a text data object, a graphical data object, or an animated data object. Another factor can be whether specific text terms are present in the HTML document. Another factor can be whether a particular number of tabs and spaces are present in the HTML document.

The data objects can be stored as variables into a string. The string can be associated with an interactive exercise of the XML document. The data objects that are stored in the string can be are integrated in with the interactive exercise of the XML document. The XML document can be rendered into a format that a browser user interface requires. The data objects can be retrieved from the string and displayed with the interactive exercise in the browser user interface.

In accordance with an interface for a presentation system, a builder can be used to generate an XML document based on header tags of HTML document. The builder can determine an arrangement for the XML document based on the header tags. The builder can determine a structure of the XML document based on pseudo tags associated with the header tags. The builder can determine a beginning and ending of pages based on the header tags. The builder can determine an arrangement of data objects for display on a user interface based on the header tags.

The builder can determine a type interactive exercise based on the header tags of the HTML document. The type of interactive exercise can be a dichotomous exercise, a multiple choice exercise, a multiple select exercise, a matching exercise, or an ordered list exercise.

The builder can use a number of factors to determine a type of interactive exercise. One factor can be the type of data stored in the HTML document. Another factor can be the text stored in the HTML document. Another factor can be the number of tabs and spaces in with the HTML document.

In accordance with an interface for a presentation system, a method and system can develop an interactive presentation in XML. A builder can build an XML document based on tables stored in a HTML document. The contents of the XML document can be determine based on factors associated with the table. One factor can be a number of cells in the table. Another factor can be a number of columns in the table. Another factor can be a number of rows in the table. Another factor can be whether certain text punctuation is used in a cell of the table. Another factor can be whether there are any text data present that are generally associated with interactive exercises. The text data can be a term, such as correct, incorrect, yes and no.

The table can indicate a type of interactive exercise. The type of exercise can be a dichotomous exercise, a multiple choice exercise, a multiple select exercise, and an ordered list exercise. Based on the table, a layout of page assets associated with the XML document can be determined, and the time-coding data for displaying the page assets of the XML document in synchronization on a user interface can be determined.

Based on the table, a structure of the XML document, a beginning and ending of pages, and an arrangement of data objects for display on a user interface can be determined. Based on the table, a synchronization scheme for displaying media objects on a user interface can be determined. The table can also indicate a type of interactive exercise to be displayed in the XML document can be determined. The tags can define a structure of the XML document.

Data objects associated with the table can be stored into a string as variables. The data objects can be integrated in the interactive exercise. The data objects can be either text data object, graphical data object, or animated data object. The data objects stored in the string can be integrated in with the interactive exercise of the XML document. The XML document can be rendered into a format that a browser user interface requires. The rendered XML document can be displayed with the interactive exercise on the browser user interface. The interactive exercise of the XML document can be displayed with the data objects.

The XML document can be linked to an XML player. The XML player can render the XML document into a format that a browser user interface requires. The XML player can include JavaScript programs, an interactive exercise engine and supporting files. The XML document can be rendered by the XML player and can be part of an interaction presentation.

In another aspect of the invention, a builder can store data objects associated with the HTML document into a string as variables. An interactive exercise engine can processes the string. The data objects associated with the HTML document can be either a text data object, graphical data object, or an animated data object. An XML player can interface with an interactive exercise engine, and render the XML document for a browser user interface. The XML player can interface with the interactive exercise engine in order to integrate the variables stored in the string into the interactive exercise.

In accordance with an interface for a presentation system, a system and method can develop an interactive presentation in XML format. The system can have a means for generating an XML document based on a table stored in a HTML document. There can be a means for accepting a variable stored in the table, and a means for integrating the variable into an interactive presentation. There can be a means to render the XML document in a browser user interface.

According to another aspect of the invention, a system can develop an electronic learning presentation that utilizes an XML player. The system can include an XML player for rendering XML data in a browser user interface.

In accordance with an interface for a presentation system, a system and method can develop an interactive learning environment. The system can include an electronic document having a table with data objects stored in cells of the table. A builder module can convert the electronic document into an XML document that includes an interactive exercise. The data objects can be associated with variables and processed in a string. When the interactive exercise is displayed on the user interface, the data objects can be included.

In accordance with an interface for a presentation system, a method and system can implement an electronic learning navigation environment over a communications network. A course structure file can define a structure of an interactive presentation. The course structure file can reference information about pages included in the interactive information. The course structure can be an XML document that includes aliases to pages and page assets in the course.

A table of contents can be included in the electronic learning navigation environment. The table of contents can dynamically synchronizes its assets when a user navigates through the interactive presentation. The interactive presentation can enable a user to navigate through the entire interactive presentation using one keystroke interaction. In one embodiment, the keystroke interaction can be the right arrow key. Each keystroke command can have a corresponding mouse interaction.

In accordance with an interface for a presentation system, a method and system can implement an electronic learning navigation environment over a communications network. A progress bar can display three types of information: an amount of a page delivered, a current page location within course structure file, and a number of time-markers present in a page.

Each time-marker can be a node in an interactive presentation time-line. The time-markers can be used to navigate to specific frames in the interactive presentation. Mouse interactions or keystroke interactions can be used to navigate the interactive presentation time-line with the time-markers.

The keystroke interaction can instruct a navigation display engine to navigate to a specific frame within the interactive presentation time-line. The time-markers can be time-coded to preserve synchronization during navigation. The navigation display engine can process navigation interactions and display the interactive presentation on the user interface. An interactive exercise engine can process all interactions associated with interactive exercises.

In accordance with a system for accelerating delivery of electronic presentations, a method and system can deliver content over a communications network. An interactive presentation can have a plurality of pages. A pre-loading engine can request a priority delivery of a page asset from the plurality of pages. The priority delivery can be based on the type of the page asset. The pre-loading engine can pause during a navigation event.

The type of page asset can be either XML data, JavaScript data, or HTML data. The interactive presentation can reference the page assets of the plurality of pages in a course structure file. The page assets can be referenced in a particular section of the course structure file that is for the pre-loading engine. The pre-loading engine can determine anticipated pages, and can deliver the page assets for the anticipated pages to the course structure file. The references to the anticipated pages can be replaced by the actual page assets of the anticipated pages.

In accordance with a system for accelerating delivery of electronic presentations, a method and system can implement an electronic learning system. The assets of an anticipated page can be delivered to a client system memory and cache location. Once the assets of the anticipated page have been delivered, their references in the course structure file can be removed.

In another aspect of the electronic learning system, the actual XML data of an anticipated page can replace its corresponding XML reference in the course structure file. The remaining page assets of the anticipated page can be delivered after the actual XML data replaces its XML reference in the course structure file. The actual XML data of the anticipated page can be delivered to a cache location and a memory location.

In another aspect of the electronic learning system, the actual JavaScript data of an anticipated page can replace its corresponding JavaScript reference in the course structure file. The remaining page assets of the anticipated page can be delivered after the actual JavaScript data replaces its corresponding JavaScript reference in the course structure file. The actual JavaScript data of the anticipated page can be delivered to a cache location and a memory location.

In accordance with a system for accelerating delivery of electronic presentations, a system and method can implement an electronic learning environment. An interactive presentation can include a plurality of pages that are displayed over a communications network. The navigational display engine can display at least one page having an extensible markup language object. A pre-loading engine can request a priority delivery of the at least one page from the plurality of pages. The navigation display engine can include an XML player to process extensible markup language in the interactive presentation.

### BRIEF DESCRIPTION OF THE DRAWINGS

The foregoing and other objects, features and advantages of the invention will be apparent from the following more particular description of the Computerized Learning System, as illustrated in the accompanying drawings in which like reference characters refer to the same parts throughout the different views. For clarity and ease of description, the drawings are not necessarily to scale, emphasis instead being placed upon illustrating the principles of the invention.

FIG. 1 is a diagram of network systems architecture in accordance with the present invention.

FIG. 2 is a diagram illustrating the different layers of an interactive presentation according to an embodiment of the present invention.

FIG. 3 is a diagram illustrating an interactive presentation displayed in a browser user interface.

FIG. 4 is a diagram illustrating an embodiment of an animation-video region of the user interface.

FIG. 5 is a diagram illustrating a text based dichotomous interactive e-learning exercise displayed in the animation-video region of the user interface.

FIG. 6 is a diagram illustrating a text based multiple choice interactive exercise displayed in the animation-video region of the user interface.

FIG. 7 is a diagram illustrating a graphical multiple choice interactive e-learning exercise displayed in the animation-video region of the user interface.

FIG. 8 is a diagram illustrating a text based multiple select interactive e-learning exercise displayed in the animation-video region of the user interface.

FIG. 9 is a diagram illustrating a graphical drag and drop interactive e-learning exercise displayed in the animation-video region of the user interface.

FIG. 10 is a diagram illustrating a graphical puzzle interactive e-learning exercise displayed in the animation-video region of the user interface.

FIG. 11 is a diagram illustrating a graphical ordered list interactive e-learning exercise displayed in the animation-video region of the user interface.

FIG. 12 is a diagram illustrating an embodiment of the animation-video region of the user interface.

FIG. 13 is a diagram illustrating a table of contents of the user interface.

FIG. 14 is a diagram illustrating an embodiment of the table of contents.

FIG. 15 is a flow diagram describing the steps of user interaction with the interactive presentation.

FIG. 16 is a flow a diagram illustrating the hyper-download process in accordance with an embodiment of the present invention.

FIG. 17 is a flow diagram describing the steps of the hyper-download system according to an embodiment of the present invention.

FIG. 18 is a diagram depicting an XML data reference link in the course structure file.

FIG. 19 is a diagram depicting the corresponding XML data of an anticipated page.

FIG. 20 is a diagram illustrating the resulting XML data in the course structure file.

FIG. 21 is a diagram illustrating the computer system architecture for creating an interactive presentation according to an embodiment of the present invention.

FIG. 22 is a diagram illustrating an embodiment of the authoring environment of FIG. 21.

FIG. 23 is a flow diagram describing the steps of the CME application.

FIG. 24 is a diagram illustrating the interface of the CME application.

FIG. 25 is a diagram illustrating the template manager interface of the CME application.

FIG. 26 is a diagram illustrating the time-coder interface of the CME application

FIG. 27 is a flow diagram describing the steps of the x-builder application.

FIG. 28 is a diagram illustrating the x-builder interface displaying the organization of imported content stored in the common files database.

FIG. 29 is a diagram illustrating the interface of an x-builder content editor interface.

FIG. 30 is a diagram illustrating an embodiment of the x-builder application interface.

FIG. 31 is a diagram illustrating an embodiment of the x-builder application interface.

FIG. 32 is a diagram illustrating computer systems architecture for creating an interactive presentation according to an embodiment of the present invention.

FIG. 33 is diagram illustrating an embodiment of the XML player.

FIG. 34 is a diagram describing the steps of the authoring system of FIG. 31.

FIG. 35 is a diagram illustrating an embodiment of FIG. 31.

FIG. 36 is a diagram illustrating a table for a dichotomous exercise.

FIG. 37 is a diagram illustrating the table data of FIG. 35 in a dichotomous interactive exercise displayed on the animation-video region of the user interface.

### DETAILED DESCRIPTION

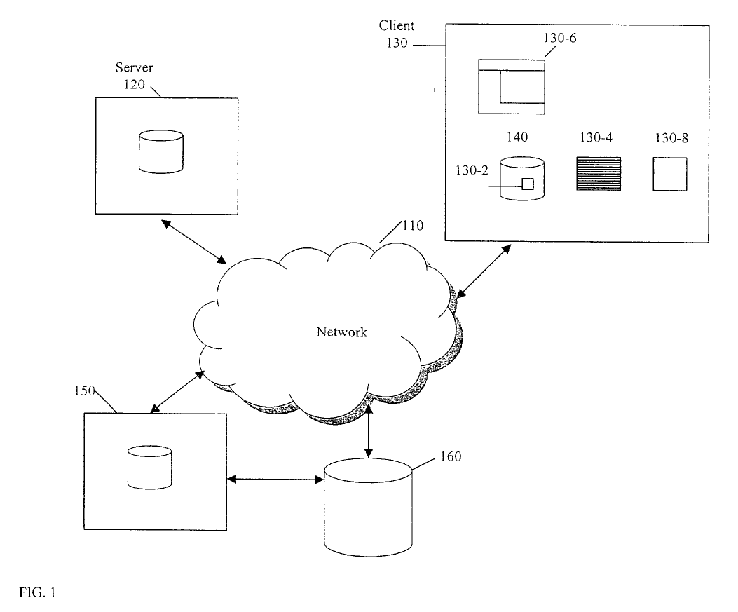

FIG. 1 is a diagram of network systems architecture in accordance with an embodiment of the present invention. An interactive presentation is distributed over a network 110. The interactive presentation enables management of both hardware and software components over the network 110 using Internet technology. The network 110 includes at least one server 120, and at least one client system 130. The client system 130 can connect to the network 110 with any type of network interface, such as a modem, network interface card (NIC), wireless connection, etc. The network 110 can be any type of network topology, such as Internet or Intranet.

According to a certain embodiment of the invention, the network 110 supports the World Wide Web (WWW), which is an Internet technology that is layered on top of the basic Transmission Control Protocol Internet Protocol (TCP/IP) services. The client system 130 supports TCP/IP. The client system 130 includes a web browser for accessing and displaying the interactive presentation. It is desired that the web browser support an Internet animation or video format, and a such as Flash™, Shockwave™, Windows Media™, Real Video™, QuickTime™, Eyewonder™, a mark-up language, such as any dialect of Standard Generalized Markup Language (SGML), and a scripting language, such as JavaScript, Jscript, ActionScript, VBSscript, Perl, etc. Internet animation and video formats include audiovisual data that can be presented via a web browser. Scripting languages include instructions interpreted by a web browser to perform certain functions, such as how to display data.

An e-learning content creation station 150 stores the interactive presentation on the server 120. The e-learning content creation station 150 includes content creation software 150 for developing interactive presentations over a distributed computer system. The e-learning content creation station 150 enables access to at least one database 160. The database 160 stores interactive presentation data objects such as text, sound, video, still and animated graphics, applets, interactive content, and templates.

The client system 130 accesses the interactive presentation stored in the database 160 or from the server 120 using TCP/IP and a universal resource locator (URL). The retrieved interactive presentation data is delivered to the client system 130. At least one data object of the interactive presentation is stored in a cache 130-2 or virtual memory 130-4 location on the client system 130.

According to an embodiment of the present invention, the client system 130 is operated by a student in an e-learning course. The e-learning course can relate to any subject matter, such as education, entertainment, or business. An interactive presentation is the learning environment or classroom component of the e-learning course. The interactive presentation can be a web site or a multimedia presentation.

Embodiments of this invention, such as the interactive presentation, or more specifically, the e-learning course product, are commercially available from Telecommunications Research Associates, LLC of St. Marys, Kans.

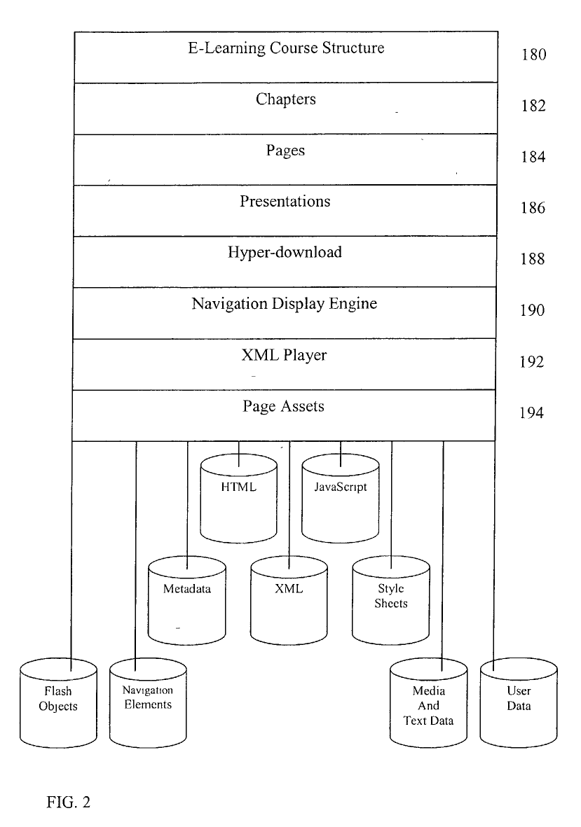

FIG. 2 is a diagram illustrating the different layers of the interactive presentation content according to one aspect of the invention. The interactive presentation provides an e-learning course structure layer 180. The e-learning course structure layer 180 defines the structure of the interactive presentation. The e-learning course structure layer 180 includes a chapter layer 182 that features chapters or lessons in the e-learning course. Each chapter layer 182 includes a page layer 184.

The page layer 184 represents the pages in the chapter layer 182. The pages illustrate the subject matter of the chapter. The subject matter is more particularly represented in a presentation layer 186, which provides instructional data, navigational tools and interactive exercises for the e-learning course.

A hyper-download layer 188 includes a pre-loading engine that systematically delivers specific layers of content from the interactive presentation to a memory location 130-4 or a scratch location 130-2, such as a cache.

The content that is delivered by the pre-loading engine can change in response to student input. Student input can trigger interactive and navigation events. The student input is detected by a navigation display layer 190. The navigation display layer 190 processes student input and displays the page layer 184 that corresponds to the student input.

When the navigation display layer 190 displays a page from the page layer 184 that is an Extensible Markup Language (XML) document, an XML player 192 is used to process and display the page. The XML player 192 consists of supporting files, such as JavaScript files. The XML player 192 can parse XML data and render it into a format that the browser requires. Once the XML data is rendered by the XML player 192, the navigation display layer 190 can display it in a browser user interface.

The page assets layer 192 consists of data objects that can be linked by the different layers of content in the interactive presentation. For example, page assets are referenced in the page layer 184 and the presentation layer 186. The data objects in the page assets layer 192 can provide instructional, navigational and interactive content. The data objects of the page assets layer 192 can include any form of web-deliverable content such as Flash objects, navigation elements, metadata, HTML, XML, JavaScript, style sheets, media and text data, and user data.

According to one aspect of the invention, the course structure layer 180 is an XML course structure file that defines the interactive presentation. The course structure layer 180 defines requirements, content and media assets associated with the layers of the interactive presentation. More particularly, the course structure layer 180 is divided into three sections: attributes, structure, and content.

The attributes section defines the course title, score identification, user interface properties, peripherals, and testing attributes. The score identification attributes allow the interactive presentation to track a student's scores on a particular interactive exercise. The user interface properties define the look and feel of: the table of contents, closed captioning region, toolbar, and navigational buttons. The peripherals define whether prerequisites are required to take the course, and whether the course has supplementals, objectives, job aids, and the like. For example, if the interactive presentation requires a student to have prerequisites, the attributes section of the course structure file determines whether prerequisites are required.

The course structure file defines the testing environment for the interactive presentation with the testing attributes. The testing attributes can define a mode associated with exercises. In particular, the testing attributes define the number of attempts a student can have at a test or exercise. The testing attributes further define whether answers, scores, remediation, or feedback can be displayed on the user interface. The testing attributes also determine whether a student can navigate incorrect answers and whether the user interface displays a check it button for an exercise.

The structure section defines the structure for the chapters 182, and the pages 184 within the chapters 182. In particular, the chapters 182 are further defined as folders in the course structure. Each folder is given a folder title. Each page 184 is referenced with an alias within a folder, such as <folder><page ref=‘c2-1’></folder>. With this structure for the folders (chapters) and pages, the XML course structure can point to every chapter 182 and page 184 in the course structure 180.

The content section defines the specific layers of content for the pre-loading engine of the hyper-download layer 188 to download. Specifically, each page in the page layer 184 is linked in the content section of the XML course structure file. An example of one page that is linked in the content section of the XML course structure file appears as follows:

<content>

<c2-13>
<title>Summary</title>
<type>scriptedflash</type>
<data ref=″c2- 13.XML″/>
<mediafiles>55916-0001.swf</mediafiles>
</c2-13>

</content>

The page alias, <c2-13>, the title of the page, <title>Summary</title>, the type of page, <type>scriptedflash</type>, a data reference link, <data ref=“c2-13.XML”/>, and specific media files <mediafiles>55916-0001.swf</mediafiles> are referenced in the content section of the XML course structure file. In this example, some page assets 194 are referenced, such as the data reference link, which references an XML file, and the media file, which references a Shockwave file.

According to another aspect of the present invention, the course structure file is stored in a JavaScript array. Each page in the page layer 184 is a node in the JavaScript array. Each node can have corresponding attributes.

By storing the entire course structure in an course structure file (as XML or in a JavaScript array), the interactive presentation can simplify the design of the course for a developer, and enhance the viewing experience for a user. In particular, the course structure file enables all components of the interactive presentation to be fully integrated with the course structure. Components such as navigational elements, menus, software components, and the like can retrieve the course structure directly from the course structure file. Each component can receive the most update information about the course structure with the course structure file. Furthermore, the course structure file provides a centralized approach to integrating and developing a multi-megabyte presentation.

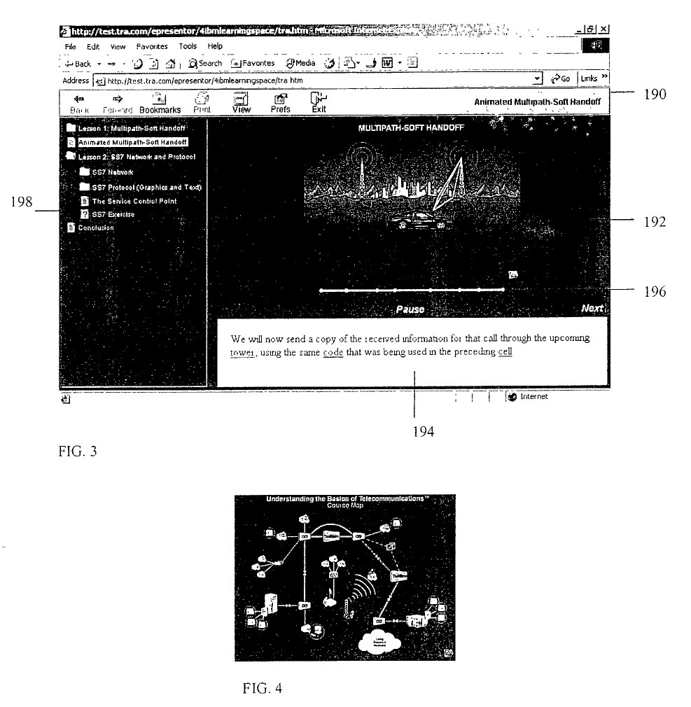

In FIG. 3, an interactive presentation is displayed in a browser user interface 130-6. In general, the layout of the user interface features four specific areas that display instructional, interactive or navigational content. These four areas are animation-video region 192, closed caption region 194, toolbar 196 and table of contents 198.

The animation-video region 192 can display any type of data object. For example, the animation-video region can display Macromedia Shockwave™ objects, web-deliverable video, slide show graphics with synchronized sound, or static graphics with synchronized sound.

FIG. 4 is a diagram illustrating an embodiment of an animation-video region 192 of the user interface 130-6. The animation-video region 192 displays an example course map. The course map can be a graphic or animation. The course map provides an overall view of the course chapters and sections. The course map is a navigational tool that allows students to navigate to a specific topic or section of a chapter or lesson within the course. The course map links to the course structure file, which defines the structure of the interactive presentation.

Technical content interface buttons can be used in connection with the course map. If selected, the buttons can perform navigation events. One example of an action performed in connection with a navigation event is to display a course introduction movie. If the course introduction movie is pre-loaded on the client system 130, it is displayed on the user interface 130-6. If the introduction movie is not pre-loaded, it is delivered from the server 120 via hyper-download and then displayed.

In addition to navigational tools, the animation-video region 192 of FIG. 3 can display interactive exercises. An interactive exercise engine displays contents of an interactive exercise. The interactive exercise engine can be written in ActionScript or JavaScript. The interactive exercise engine determines the interactive exercise contents based on a mode associated with the interactive exercise. The mode can be defined by the attributes of the course structure file. In particular, the course structure file can instruct the interactive exercise engine to display an interactive exercise according to a specific mode. For example, the interactive exercise engine can display the interactive exercise in: exercise mode, exercise with the check it button mode, quiz mode, and test mode. The mode defines the content displayed on the user interface and the navigation elements associated with the interactive exercise. The mode also defines the testing environment for the interactive exercise.

Interactive exercises are desirable because they enhance the e-learning experience of the student. Interactive exercises provide the instructor interactive component that is lacking in the conventional e-learning environment. Specifically, the interactive exercises provide students with the opportunity to apply their knowledge and skills. Interactive exercises also provide feedback to the students when the students answer, and allow students to compare their answers with the correct answer.

There are five general types of interactive e-learning exercises: dichotomous, multiple choice, multiple select, matching, and ordered list.

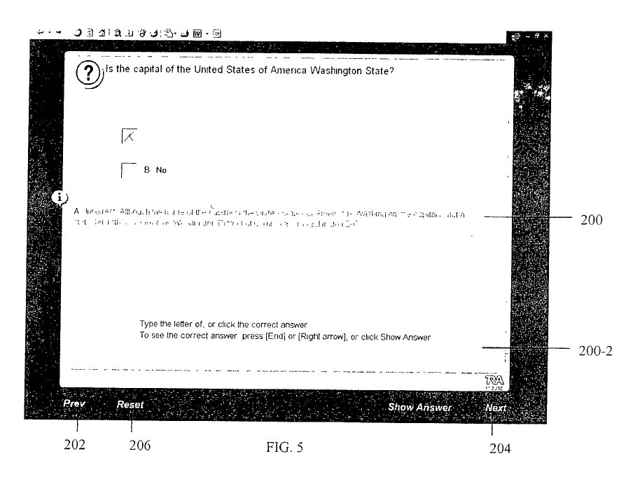

FIG. 5 is a diagram illustrating a text based dichotomous interactive e-learning exercise displayed in the animation-video region 192 of the user interface 130-6. An interaction with a single question and exactly two answers in a dichotomous exercise. The answer options shown in FIG. 5 are A/B variables. The answers can be selected via mouse interaction or keystroke interaction.

Text accompanying the student's selection of an answer is feedback 200. Links to review relevant portions of the course are called remediation objects 200-2. A remediation object is displayed when an answer is selected. The remediation object 200-2 provides feedback to the user by displaying a link to additional information.

Exercises can display navigation buttons that the user can select. A previous button 202 can is displayed and scripted to load a previous page. A next button 204 is displayed and scripted to load a next page. A right arrow keystroke interaction performs the same function as the next button 204. The next button 204 and the right arrow keyboard command have a corresponding record number, which can be specified by remediation link. A reset button 206 is scripted to reset or clear a user's current answer or selection.

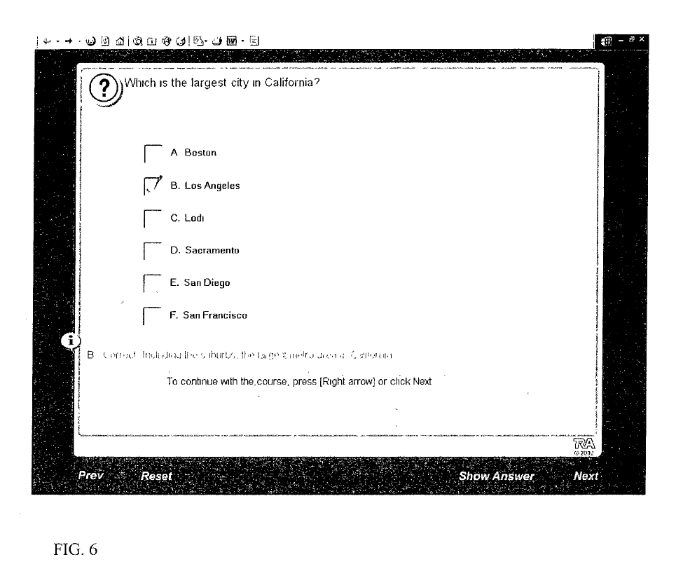

FIG. 6 is a diagram illustrating a text based multiple choice interactive exercise displayed in the animation-video region 192 of the user interface 130-6. An interaction with a single question and several answers (only one of which is correct) is a multiple choice exercise.

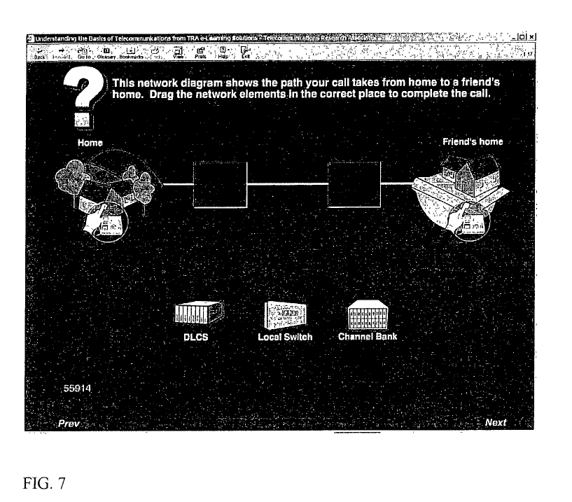

The interactive exercises can include graphical objects that the user can interact with. FIG. 7 is a diagram illustrating a graphical multiple choice interactive exercise that is displayed in the animation-video region 192 of the user interface 130-6. A graphical object can be part of the interaction, such as a draggable object. The graphical object can be included in the exercise as part of the user's interaction with the question or the answer.

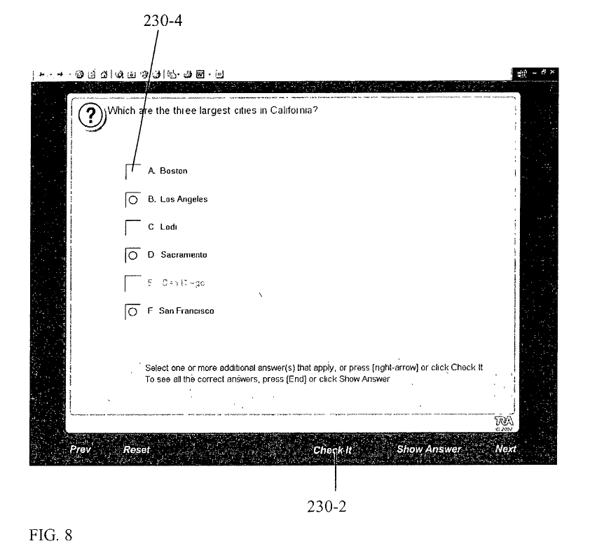

FIG. 8 is a diagram illustrating a text based multiple select interactive e-learning exercise displayed in the animation-video region 192 of the user interface 130-6. An interaction with a single question and several answers (more than one of which is correct) is a multiple select exercise.

This multiple select exercises is in check it button mode, which displays a check it button 230-2. If selected, the check it button 230-2 can notify the user that their selection input is correct or incorrect. Specifically, the check it button 230-2 is scripted to display a correct answer. When the check answer button 230-2 is selected, the answer selected is graded and scored. This score is stored in a cookie identifier. The cookie identifier can be stored on the client system 130 or on the server 120. The server 120 can be a learning management system. The user can log in to the learning management system. The learning management system allows students taking the e-learning course to login and experience the interactive presentation. The students can also store notes in their user data on the learning management system.

Each time the user makes a selection in one of the answer fields 230-4, the user's selection choice is stored in a cookie identifier even when the user does not select the check it button 230-2 . For example, when the user selects an answer, the user's score is stored in a cookie identifier. The user does not need to input the answer with the check it button 230-2 for the user's score to be stored in the cookie identifier. The user selects the check it button 230-2 to determine if their answer is correct, and to receive feedback and remediation.

Multiple select exercises can be rendered in several different formats. For example, multiple select exercise can include drag and drop interactions and puzzle interactions.

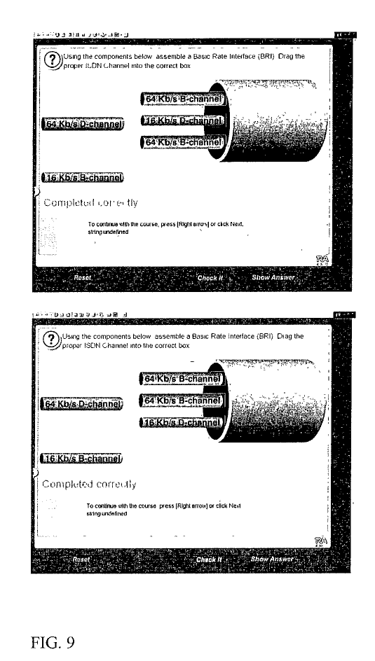

FIG. 9 is a diagram illustrating a graphical drag and drop interactive e-learning exercise displayed in the animation-video region 192 of the user interface 130-6. The drag and drop exercise is displayed as a sequence of interaction events to illustrate how the interface changes as a user drags a graphical object and drops it into a drop zone.

The drag and drop interactive exercise allows the user to drag one graphical object at a time to the correct drop zone. The drag and drop interactive exercise includes embedded code that identifies the drop zones and the hot spots in the interaction. The drop zones and hot spots specify particular coordinates on the graphic. Graphical coordinates can be used in multiple choice, multiple select and drag and drop interactions. A drag and drop interactive exercise can be variations of the multiple select or matching exercises.

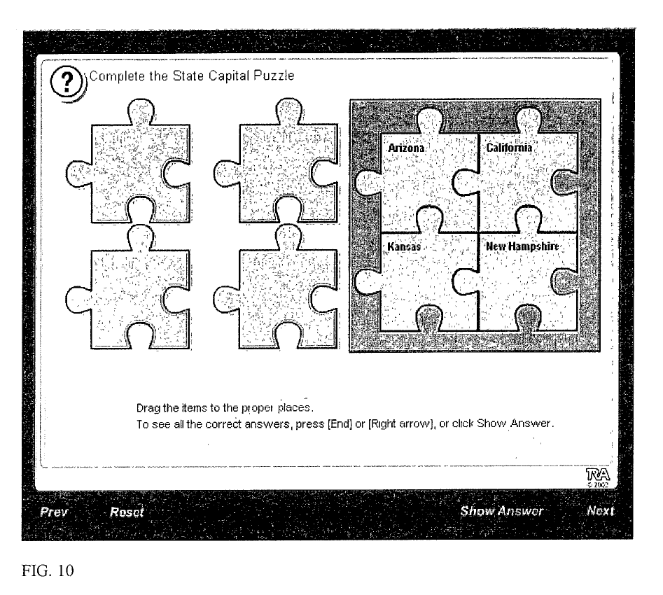

FIG. 10 is a diagram illustrating a graphical puzzle interactive e-learning exercise displayed in the animation-video region 192 of the user interface 130-6. The puzzle exercise provides an interaction with multiple questions that must be matched. Puzzles are similar to drag and drop exercises.

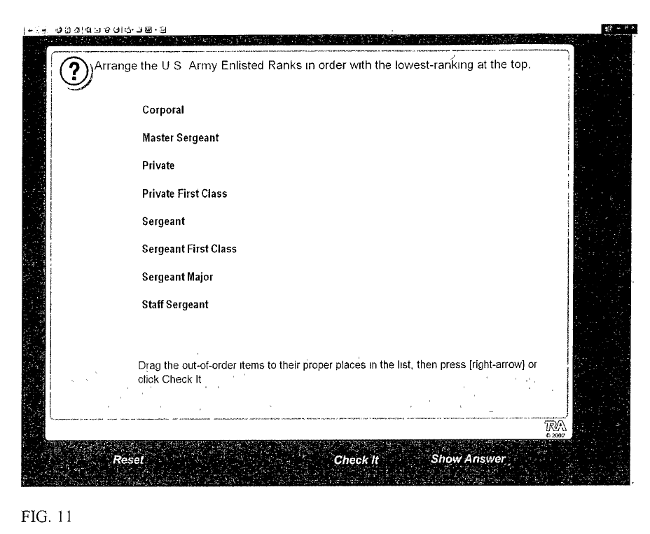

FIG. 11 is a diagram illustrating a graphical ordered list interactive e-learning exercise displayed in the animation-video region 192 of the user interface 130-6. Ordered list interactions present the student with a list of items that are to be placed a specified order.

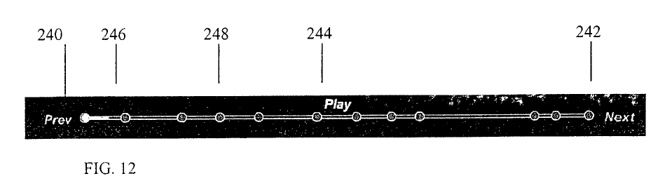

FIG. 12 is a diagram illustrating an embodiment of the animation-video region 192 of the user interface 130-6. The animation-video region 192 displays a course navigation bar. The course navigation bar provides navigation/playback control buttons. The user can navigate through sections of the interactive presentation by using the navigation/playback control interface buttons displayed with the course navigation bar. The navigation/playback control interface buttons include control elements such as a previous button 240, next button 242, pause/play button 244, and progress bar 246. If the a navigation/playback interface button is selected, it can initiate navigation events.

The progress bar 246 displays three types of information to the user. The amount of the page delivered to the client system 130 is displayed. The current page location within course structure file, and the number of time-markers 248 present in the course page are also displayed.

Each time-marker 248 is a node or frame in the interactive presentation time-line. The time-markers 248 can be used to navigate to specific frames in the interactive presentation. A user can use a mouse interaction or keystroke interaction to navigate the interactive presentation time-line using the time-markers 248. Mouse and keystroke interactions can be coded with scripting languages. Interface buttons can be created in Flash or dynamic hypertext markup language (DHTML). Mouse and keystroke interactions can be interpreted by a browser or processed with an ActiveX controller.

When navigating with the time-markers 248, the synchronization of animation-video region 192, closed caption region 194, toolbar 196 and table of contents 198 can be preserved. For example, when the user initiates a navigation event by using a keystroke interaction, such as the right arrow key, the navigation display engine can navigate to a specific frame within the interactive presentation time-line, and display text, animation and audio assets associated with the frame in synchronization. In particular, the time-markers 248 preserve this synchronization.

If a user initiates a navigation event to advance to the next time-marker 248 and the progress bar indicates that the current time-marker 248-2 is the last in the time-line, the navigation display engine can display the next page in the chapter from the cache location 130-2. If the next page is not stored in the cache location 130-2, the hyper-download system delivers the page. When the next page is accessible from the client system 130, the audio-visual contents of the next page are played-back in the animation-video region 192, the closed caption region 194, the toolbar 196 and the table of contents 198 in synchronization. Specifically, a function is called that retrieves the next text element of the closed caption region from an array and writes that text element. By storing the text elements of the closed caption region in an array, the navigation display engine can display the text in the closed caption region in synchronization with the contents of the next page, and thus, preserve the viewing experience for the user.

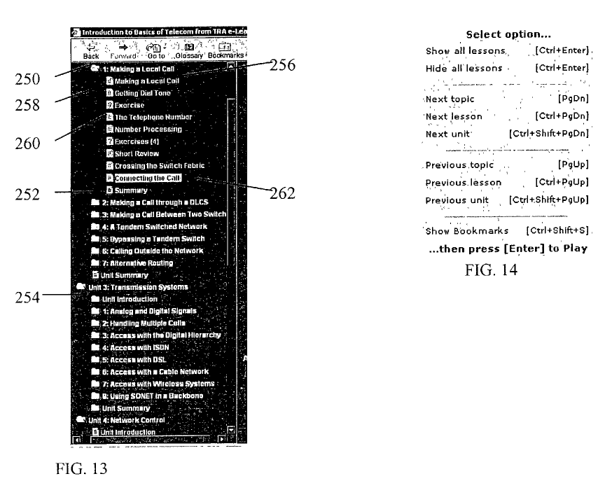

FIG. 13 is a diagram illustrating a table of contents 198 of the user interface 130-6. The table of contents 198 is a navigation tool that dynamically displays the course structure in a vertical hierarchy providing a high-level and detailed view. The table of contents 198 enables the user to navigate to any given page of the interactive presentation. The table of contents 198 uses the course structure file to determine the structure of the interactive presentation. The user can navigate the table of contents 198 via mouse interaction or keystroke interaction.

The table of contents 198 is a control structure that can be designed in any web medium, such as an ActiveX object, a markup language, JavaScript, or Flash. The table of contents 198 is composed of a series of data items arranged in a hierarchical structure. The data items can be nodes, elements, attributes, and fields. The table of contents 198 maintains the data items in a node array. The node array can be an attribute array. The table of contents 198 maps its data items to a linked list. The data items of the table of contents 198 are organized by folders 250 (chapters, units or sections) and pages 252. Specifically, the folders 250 and pages 252 are data items of the table of contents 198 that are stored in the node array.

Each folder 250 is a node in the node array. Each folder 250 has a corresponding set of attributes such as supporting folders 254 and pages 252, a folder title 256, folder indicators 258, and XML and meta tags associated with the folder. The folder indicators 258 can indicate the state of the folder 250. For example, an open folder can have an icon indicator identifying the state of the open folder. The XML and meta tags can be used to differentiate instances of types of content and attributes of the folders 250.

Each page 252 is a supporting structure of a folder 250. Each page 252 has a corresponding set of attributes such as supporting child pages, an icon that shows the page type, a page title, and any tags associated with the contents of the page 252. The pages 252 have page assets that can be tagged with XML and meta tags. The tags define information from the page assets.

When the user selects a folder 250 within the table of contents, the navigation display engine toggles between an open state and a closed state. Specifically, the table of contents 198 either exposes or hides some of the attributes of the selected folder.

When the user selects a specific page 252 (via mouse click interaction or keystroke interaction) from the table of contents 198, the browser displays the current page. The state of the current page 252 (such as the topic title 256) is displayed as subdued on the user interface 130-6, and an icon appears indicating the state of the page 252. The state 252 of the page indicates whether the page has been visited by the user.

The state of the page is maintained even if the client system 130 disconnects and reconnects to the network 110. This accommodates students in an e-learning course that are prone to periodically connect and disconnect to the interactive presentation on the network. The state of the page is determined by a cookie identifier. For example, the state of the page can be determined by processing the user data for a cookie identifier stored in cache 130-6 or memory 130-4.

According to one aspect of the invention, the table of contents 198 includes a lookup table, a hash table, and a linked list. The table of contents 198 maps its data items, such as its nodes and attributes 250, to the linked list. The data items are searchable and linked by the linked list. The table of contents 198 data items can be searchable via a search engine or portal. The search can locate and catalog the data items of the table of contents. When a search query is entered, the search produces a search result (if one exists) linking the data item. In another embodiment, the XML and meta tags from the folders and pages are used to search for particular instances of content and attributes of the individual folders 250 and pages 252.

FIG. 14 is a diagram illustrating an embodiment of the table of contents. The table of contents offers an additional navigational menu that can be accessed via a right click mouse interaction or keystroke interaction. The diagram displays the right click menu options.

In general, mouse and keystroke interactions can enhance the user's viewing and learning experiences. Specifically, the mouse and keystroke navigational features of the interactive presentation of FIG. 3 are designed to be versatile, and user friendly. Typically, e-learning presentation do not provide both versatile and user friendly navigation designs. For example, conventional e-learning web sites do not utilize dual navigation features, such as a mouse interaction and keystroke interaction that perform the same task.

According to one aspect of the invention, the interactive presentation includes dual navigation controls that perform the same task. A user can control elements of the interactive presentation via interface buttons and associated keystroke commands. Each button calls associated functions that instruct the interactive presentation to display specific course elements. Each button can have a corresponding keystroke interaction. Examples of interface buttons, their corresponding keystroke interaction, and associated funtion are as follows.

| | | Alternate | | |
|---|---|---|---|---|
| Button | Location | [Key Stroke] | Tool Tip | Function |
| Prev | Animation- | [Up Arrow Key] | Preceding Page | Navigate to the previous |
| | video region | or [PgUp | | page in sequence |
| Next | Animation- | [Down Arrow | Following Page | Navigate to the next page |
| | video region | Key] or [PgDn] | | in sequence |
| Objectives | Animation- | | Learning goals | Calls a new window |
| button | video region | | for the lesson (or | containing course/lesson |
| | | | Unit) | objectives |
| Prerequisites | Animation- | | Topics the | Calls a new window |
| interface button | video region | | student should | displaying course content |
| | | | know prior to | containing |
| | | | taking the lesson | animations/text/table of |
| | | | | contents/progress bar |
| Supplementals | Animation- | | Additional, in- | Calls a new window |
| button | video region | | depth | containing supplemental |
| | | | information on | course material and |
| | | | the topic | marks the associated |
| | | | | entry in the table of |
| | | | | contents as “visited” |
| Job Aids | Animation- | | Printable | Calls a new window |
| button | video region | | summary for use | displaying Job Aids |
| | | | on the job | |
| Related Info | Animation- | | Additional | Calls a new window |
| button | video region | | information from | displaying Information |
| | | | another part of | related to the current |
| | | | the course | topic. |
| Progress bar | Animation- | | Refer to “Dots in | Shows progress of |
| | video region | | Progress Bar” | content download (gray) |
| | | | | and progress of |
| | | | | presentation (white) |
| Dots in Progress | Progress Bar | [Left Arrow] | Repeat this | Rewind to the beginning |
| Bar | | | paragraph | of the current learning |
| | | | | point or navigate |
| | | | | backwards (depending on |
| | | | | how far into the current |
| | | | | point that the student is) |
| | | | | within in the current page |
| | | | | retrieve the associated |
| | | | | text element from an |
| | | | | array and write that |
| | | | | element into the closed |
| | | | | caption region |
| Dots in Progress | Progress Bar | [Right Arrow] | Skip Ahead | Advance to the next |
| Bar | | | | Learning Point within the |
| | | | | current Page, retrieve the |
| | | | | associated text element |
| | | | | from an array and write |
| | | | | that element into the |
| | | | | closed caption region. |
| Back | Toolbar | | Back to Page | Calls the last visited page |
| | | | “Unit-Page” | based on student location |
| | | | “Title” | in the course. (The |
| | | | | history of student |
| | | | | navigation activity is |
| | | | | stored in an Array) |
| Forward | Toolbar | | Return to Page | Calls a page of course |
| | | | “Unit-Page” | material that a student |
| | | | “Title” | has visited then “backed” |
| | | | | out of (The history of |
| | | | | student navigation |
| | | | | activity is stored in an |
| | | | | array) |
| Go to | Toolbar | | Important Links | Drop-down menu with |
| | | | into “Course | buttons that call specified |
| | | | Title” | pages associated with: |
| | | | | Course Map |
| | | | | Start of Course |
| | | | | First Technical Unit |
| Glossary | Toolbar | | Open glossary | Calls new window |
| | | | list | containing searchable |
| | | | | glossary of terms |
| | | | | appearing in course |
| Bookmarks | Toolbar | | Add/remove | Allows student to revisit |
| Bookmarks in | | | bookmarks | “bookmarker” course |
| the Table of | | | | material. Assigns |
| Contents | | | | pushpin graphic icon to |
| window | | | | Table of contents entry |
| | | | | corresponding to |
| | | | | bookmark location with |
| | | | | the course sequence. |
| Print | Toolbar | | Print Text | Dynamically |
| | | | | concatenates and writes |
| | | | | the text elements from an |
| | | | | array associated with a |
| | | | | specific page, inserts the |
| | | | | animation title and |
| | | | | copyright statement and |
| | | | | spools the document to |
| | | | | student's printer |
| View | Toolbar | | View Full Screen/ | Resizes the animation |
| | | | View Table of | movie to full |
| | | | contents and | screen/regular display |
| | | | Text | |
| Preferences | Toolbar | | User Preferences | Display window offering |
| | | | | selectable display |
| | | | | options: |
| | | | | Pause between thoughts |
| | | | | Play continuously |
| | | | | Warnings and Messages |
| | | | | Closed Caption Font Size |
| Help | Toolbar | | Display Help | Drop-down menu, |
| | | | Window | containing: |
| | | | | 1. “Quick Start” |
| | | | | 2. How to take the course |
| | | | | tutorial |
| | | | | 3. Product support |
| | | | | 4. What's new |
| | | | | 5. System requirements |
| | | | | 6. License agreement |
| | | | | 7. About TRA |
| | | | | 8. www.tra.com |

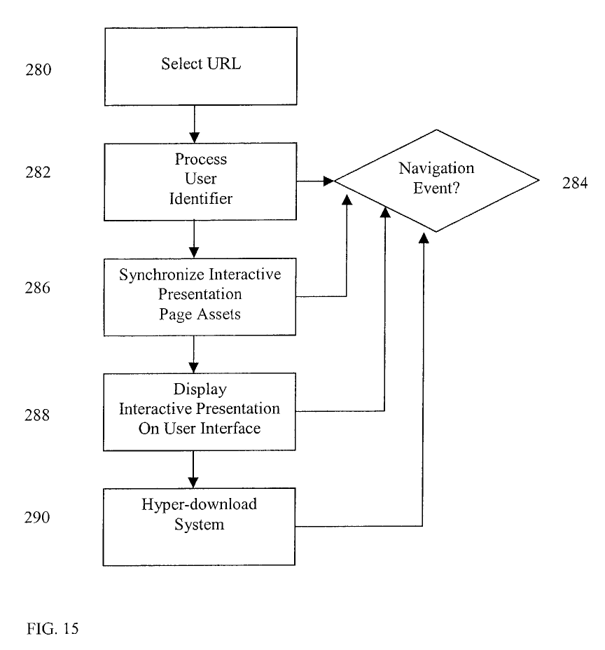

FIG. 15 is a flow diagram describing the steps of user interaction with the interactive presentation. At step 280, the user selects a URL in connection with the interactive presentation. At step 282, the navigation display engine determines the user's status by processing the user data for an identifier.

The navigation engine can also determine the user's status based on a user login to the server 120. For example, when the server 120 is the learning management system, a user can enter a user name and password to access the interactive presentation. The login data is passed to the interactive presentation.

The login data and identifiers associated with a user's status are described as user data. The user data can define the interface and contents of the interactive presentation associated with a particular user. The user data can indicate the user's navigation history, and the user's scores on interactive exercises. In particular, the user data enables the interactive presentation to track the user's actions.

The user data can be associated with navigation or cookie files. Navigation and cookie files can indicate the navigation history of the user. For example, a user that has previously visited the interactive presentation can have a cookie identifier stored on the client system 130 or on the server 120, such as the learning management server. If the navigation display engine determines that the user is a returning student, the navigation display engine provides the student with links to pages that the student accessed at the end of their previous session. The links are determined based on the student's status defined in their user data.

In certain circumstances, the navigation display engine dynamically disables or enables the user navigation controls based on the student's user data. For example, if the user data indicates that a student does not meet the prerequisites for the course, the navigation display engine can disable certain options for that user.

The navigation display engine is always monitoring the user's actions to detect navigation events. The navigation events can be triggered by the actions of the user in connection with an interactive exercise. A user can initiate a navigation event with a mouse interaction or a keystroke interaction. Navigation events can also be triggered by the navigation elements in the page assets.

When a user initiates a mouse interaction in an interactive exercise, typically, a navigation event object can be sent to the navigation display engine. The navigation event object allows the navigation display engine to query the mouse position in both relative and screen coordinates. These values can be used to ascertain a navigation event object transformation between relative coordinates and screen coordinates. With these values the navigation display engine can respond accordingly to the user's interaction.

For example, if the user is selects an answer for an interactive exercise such as a multiple select, the user data is updated to score the user's selection. The user's selection is scored even when the user does not select the check it button to input the answer. Specifically, the navigation display engine is monitoring the student's interaction, and stores a value in the user data that represents the user's current selection. If the user decides to make a different selection, and inputs a new selection, the value in the user data is updated.

If the navigation display engine detects a navigation event, the navigation display engine proceeds to step 284. At step 284, the navigation display engine processes the navigation event, and then returns to step 284.

If a navigation event is not detected, then the navigation display engine synchronizes interactive presentation page assets at step 286. The navigation display engine synchronizes the page assets according to the state of the page and the user data. For example, the navigation display engine synchronizes the table of contents to reflect a selection of a page and folder. If a user accesses a new page, and thus, initiates a navigation event, the navigation event is processed at step 284.

If the user does not initiate a navigation event, the page is displayed on the user interface at step 288. The navigation display engine processes the page into a form that the browser requires.

According to an embodiment of the present invention, the navigation display engine interfaces with the browser through an application program interface (API) to display the page or perform navigation events. For example, navigation elements can be processed through a DirectX API, or a Java Virtual Machine.

According to another embodiment of the present invention, the navigation display engine uses an XML player to display an XML document in the browser. The XML documents can include tags to instruct the navigation display engine that data is intended to be drawn from other files.

If a user initiates a navigation event, the navigation event is processed at step 284. If a navigation event is detected, the hyper-download system pauses and returns to step 284. If the user does not initiate a navigation event, the hyper-download system process begins at step 290.

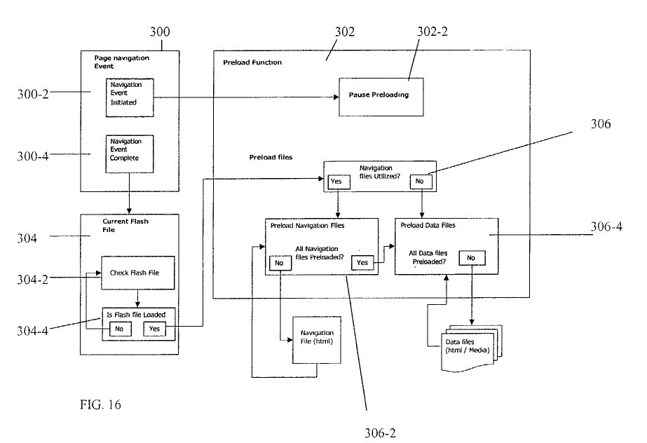

FIG. 16 is a flow a diagram illustrating the hyper-download process in accordance with the present invention. The hyper-download system enables the pre-loading engine to accelerate the delivery of interactive presentation data to the client system 130. The interactive presentation data can include any form of web-deliverable content such as video, audio, animation, applets, static graphics, text, interactive content, Javascript, XML, HTML, Action Script, navigation elements.

By way of background, when a page on a network (such as a web page) is selected by a user for viewing, the user typically waits for the page assets to be delivered and views the page. In general, a media element of the page is delivered, and displayed. As a result, the page assets are not displayed on the client system at the same time. This arrangement causes problems for pages that include synchronized animation and scrolling text (for closed captioning).

Moreover, this arrangement causes problems for e-learning interactive presentations that have chapters or sections with more than one page displaying high volume text and media data. For example, when a user is viewing a page in a chapter, and selects the next page, the user must wait for the next page to be delivered to the client system until the user can view the page. As a result, the user experiences a delay in viewing the next page's assets. In an e-learning environment, this delay in viewing consecutive pages disrupts the user's viewing and learning experience.

Different schemes have been developed to preserve the viewing experience of media over a network connection. One scheme combines the entire course content (animation, video, audio, page links, text, etc.) into a single media object. For example, Flash™, Windows Media™, Real Video™, and QuickTime™ formats can be used to combine several different types of media assets into a single file. In some situations, by combining the text and animation media assets of page content into one single file or media object, the synchronization of the media assets can be preserved when delivered to the client system. However, the preservation and effectiveness of the user's viewing experience depends on a number of factors including the method of delivery to the client system, the network bandwidth, and the volume of the presentation, such as whether it has extensive linking to other pages.

There are various approaches to delivering the media object to the client system. In general, the media object can be delivered by download, progressive download (pseudo-streaming), or media stream. A media object for download can be viewed by the user once it is stored on the client system. Progressive download allows a portion of the media object to be viewed by the user while the download of the media object is still in progress.

A media object can be sent to the client system and viewed by the user via media stream. A streaming media file is streamed from a server and is not cached on the client system. Streaming media files should be received in a timely manner in order to provide continuos playback for the user. Typically, streaming media files are neither optimized for users with low bandwidth network connections nor high bandwidth network connections that suffer from sporadic performance. High bandwidth network connections can become congested and cause network delay variations that result in jitter. In the presence of network delay variations, a streaming media application cannot provide continuous playback without buffering the media stream.

Media streams are generally buffered on the client system to preserve the linear progression of sequential timed data at the user's end. Consecutive data packets are sent to the client system to buffer the media stream. Each packet is a group of bits of a predetermined size (such as 8 kilobytes) that are delivered to a computer in one discrete data package. In general, the data packets are to be displayed the instant they are received by the user's computer. The media stream, however, is buffered and this results in a delay for the user (depending on the user network's connection). As a result, the end-to-end latency and real-time responsiveness can be compromised for users with low bandwidth network connections or high bandwidth network connections suffering from sporadic performance.

Moreover, streaming media applications are not very useful for multi-megabyte interactive presentation data. For example, when a student connects to a media stream, the contents are not cached, and therefore, the student cannot disconnect and reconnect again without disrupting their e-learning experience. Specifically, to reconnect, the student must wait to establish a connection with the server, and wait for contents to buffer before the student can actually view the e-learning content via media stream. Furthermore, a multi-megabyte course delivered via media stream can be difficult for the student to interact with and navigate through because the contents are not cached, and therefore, the student can experience a delay while interacting with the media stream.

Prior schemes can preserve the viewing experience of single low volume media objects over a high volume bandwidth network connection, such as a local area network (LAN) connection that does not suffer from sporadic performance. But, these schemes are neither suitable for multi-megabyte nor for presentations that include interactive media. In particular, they are not suitable for e-learning environments that include several pages with multi-megabyte, interactive content because the user experiences a delay in viewing linked pages.

For example, consider an e-learning course distributed over a network. The course includes chapters, and each chapter includes more than one page—each displaying high volume media objects, and providing a link to the next page. When a user selects a link to the next page or previous page in a chapter, there can be a delay before the user is able to actually view the page. Specifically, the user must wait until the media objects on the page are downloaded (unless the page is in the users's cache) or streamed before actually viewing the page in its intended form. As a result, there can be interruptions in the user's viewing experience and interactive experience. These interruptions are common to viewing such material over low and high bandwidth network connections.

According to an embodiment of the present invention, a hyper-download system 200 delivers interactive presentation data to a client system 130 in an accelerated manner without the standard interruptions common to viewing such material over a low and high bandwidth network connections. The pre-loading engine 302 systematically downloads pages of the interactive presentation. The pre-loading engine delivers the interactive presentation data to a scratch area, such as a cache 130-2 location on the client system 130. The page assets are displayed on the user interface 130-6 from the cache 130-2 location.

The cache 130-2 location is typically a cache folder on a disk storage device. For example, the cache 130-2 location can be the temporary Internet files location for an Internet browser. The cache 130-2 size for the Internet browser can be determined by the user with a preference setting. As the page assets are delivered, a conventional browser can dynamically size its cache to the amount of course content delivered from the server 120 for the length of the user's e-learning session.

In one embodiment, the pre-loading engine 302 delivers the assets of anticipated pages to the cache 240-1 sequentially based on the user's navigation history. The pre-loading engine anticipates the actions or navigation events of the user based on navigation and cookies files.

In another embodiment, the pre-loading engine 302 downloads pages to the cache sequentially from the course structure file based on the chapter and page numbers. In particular, the content section of the course structure file defines the logical structure of pages for the pre-loading engine to deliver. For example, when a user accesses a particular course section or course page number, the pre-loading engine delivers the page assets of the logically subsequent page, and logically previous page. However, this changes in response to user navigation. In the event that the user deviates from the sequential order of the course before the page has been downloaded, the pre-loading engine 302 aborts the download of the current page, calls the selected page from the central server 120, and begins downloading the selected page assets.

For example, a user selects a page from the table of contents. If the assets for that current page are cached, the page is displayed from the user's cached copy and the pre-loading engine delivers the assets of the next sequential page. If the assets for that current page have not been downloaded, assets are then delivered from the central server 120. Once a sufficient percentage of the current page's assets are displayed, playback begins of the partially downloaded page. After all of the current page assets are loaded, pre-loading resumes delivery on pages that the hyper-download system anticipates the user is going to access in future navigation events.

By pre-loading anticipated pages, the browser can display multi-megabyte course content files without the standard interruptions common to viewing such content over low and high bandwidth network connections. Specifically, the anticipated pages are accessible from the client system and can be displayed without having to be delivered when a user navigates to these pages.

Pre-loading is initiated following a navigation event 300-2 and is paused during the loading of the page 302-2. While page assets are delivered, a watcher program monitors the progress of the delivery of any Flash files (or any media content) associated with the page. The pre-loading engine ensures that the current page is completely loaded before pre-loading resumes delivery of the anticipated page.

The hyper-download system determines whether there are navigation files in the page assets 306 of an anticipated page. In conventional browsers, navigation files can increase page navigation performance. Navigation files can instruct the browser how to display and navigate the HTML content. If the hyper-download system determines that navigation files are used, the navigation files are delivered 306-4 to the client system 130. After the navigation files are delivered to the client system 130, the pre-loading engine delivers the remaining page assets 306-4 to the client system 130.

The pre-loading engine can include a limiter. The limited can limit the number of pages ahead of the current page in the course structure file that the pre-loading engine delivers to the client system.

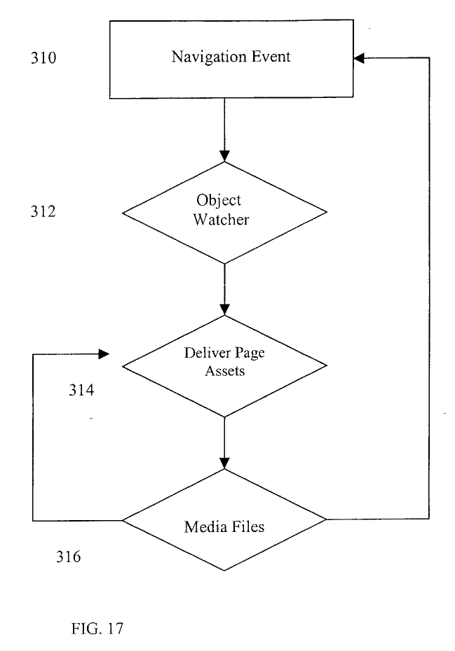

FIG. 17 is a flow diagram describing the steps of the hyper-download system according to an embodiment of the present invention. At step 310, a navigation event initializes the hyper-download process, and delivers the page that the user selected.

At step 312, an object watcher ensures or certifies that specific media objects included in the current page assets are delivered to the cache location. In particular, the object watcher certifies the completion of delivery of flash objects or shockwave objects that are included in the assets of the current page.

Once the object watcher certifies that delivery is complete, the hyper-download system proceeds to step 314. At step 314, the pre-loading engine delivers specific page assets of an anticipated page. The pre-loading engine determines a priority scheme for priority delivery of certain page assets of the anticipated page. The priority scheme is determined based on content type.

According to one embodiment of the invention, the pre-loading engine delivers XML, JavaScript and HTML page assets before delivering any other page asset. The XML, JavaScript and HTML page assets are delivered to a memory location or a cache location. For example, when an anticipated page includes XML page assets, the pre-loading engine can deliver the XML page assets before delivering any other types page assets.

Storing XML, JavaScript and HTML page assets to the memory location 130-4 enables the navigation display engine to display the anticipated page without unnecessary delays. Storing XML, JavaScript and HTML page assets to the cache location 130-2 provides an alternate mechanism for accessing the script, and therefore, increases the overall stability of the hyper-download system. For example, the delivered XML page assets cause the hyper-download system to replace any XML reference links in the current page of the course structure file.

The XML data for each page supplies a list of the assets (reference links) to be downloaded for each page. The XML tag reference links in the current page of the course structure file are replaced with the actual XML data of an anticipated page. The reference links are similar to location pointers that link to information that can be drawn from other files.

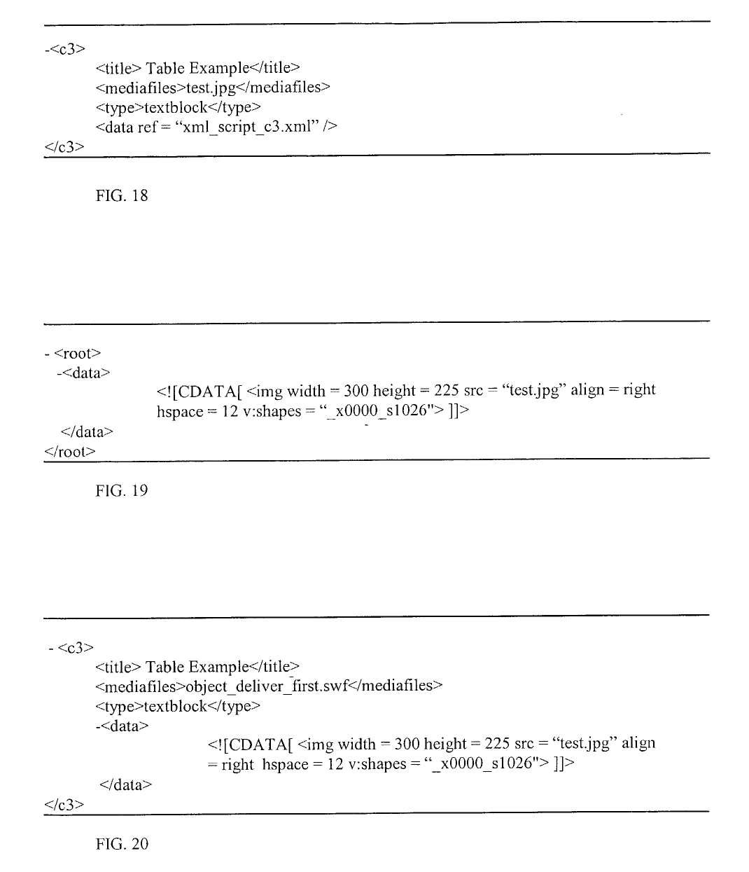

According to an embodiment of the present invention, the pre-loading engine gives a first priority status to specifically to XML data in an anticipated page. For example, the course structure file includes reference links to XML data of an anticipated page. The hyper-download system replaces the XML data reference links in the course structure file with the corresponding XML data of the anticipated page. For illustrative purposes only, a diagram depicting an XML data reference link in the course structure file is shown in FIG. 18, it is understood that the XML data provided are examples only and the XML can be scripted in any manner depending upon the particular implementation.

The course structure file includes an XML reference link that reads <data ref=“XML_script_c3.XML”/>. The XML reference link is replaced in the client system memory 130-4 with corresponding XML data of the anticipated page. FIG. 19 is a diagram depicting the corresponding XML data of the anticipated page that replaces the XML reference link in the course structure file. FIG. 20 is a diagram illustrating the resulting XML data in the course structure file. Specifically, FIG. 20 shows the XML data in the course structure file after it is replaced with the actual XML data of the anticipated page.

By only including XML data references to other pages, the pre-loading system preserves client system resources. Specifically, the amount of XML data in the course structure file is reduced because only aliases are included that reference XML data of anticipated pages. Examples of client system resources that can be preserved are client system memory 130-4, client system bandwidth 130-8 and client system storage space 140.

Once the XML data of the anticipated page are downloaded to client system, the pre-loading engine downloads the remaining assets for the anticipated page. The remaining page assets receive a secondary priority status for delivery.

In another embodiment, the pre-loading engine gives a first priority delivery status specifically to HTML data of anticipated pages. Specifically, HTML data are delivered before any other page asset in the anticipated page. The HTML data can be delivered to the client system cache 130-2, or to the client system memory 130-4. Specifically, a reference in the course structure file to the HTML data of the anticipated page is replaced with the actual HTML data of the anticipated page. By only including HTML references or aliases in the course structure file, the pre-loading system preserves client system resources.

Once the HTML data of the anticipated page are downloaded to client system, the pre-loading engine downloads the remaining assets for the anticipated page. The remaining page assets receive a secondary priority status for delivery.

In another embodiment, the pre-loading engine gives a first priority status specifically to JavaScript data of an anticipated page. Specifically, JavaScript data page assets are delivered before any other page asset in the anticipated page. The pre-loading engine delivers JavaScript to the corresponding JavaScript location in the course structure file. Specifically, the anticipated page JavaScript script location in the course structure file is replaced with the actual JavaScript script in the anticipated page in the client system memory 130-4 or the client system cache 130-2.

Once the JavaScript data of the anticipated page are downloaded to client system, the pre-loading engine downloads the remaining assets for the anticipated page. The remaining page assets receive a secondary priority status for delivery.

At step 316, the pre-loading engine delivers any remaining media assets of the anticipated page to the client system 130. Examples of remaining media assets are still images, sound files, video files, Applets, etc. The pre-loading system delivers the media assets to the user cache location 130-2.

When the pre-loading engine completes delivery of the media files, the hyper-download system returns to step 316 and delivers the priority content of the next anticipated page. Specifically, this cycle continues until a navigation event is detected or until the assets of a certain number of anticipated pages are pre-loaded in the client system 130. Due to constraints on the client system resources (such as memory) the pre-loading engine can pause when it determines that a sufficient number of pages have been delivered.

By utilizing the pre-loading of particular page assets, the hyper-download system discourages the client system from experiencing a delay when viewing anticipated pages. For example, if the user navigates to a page that is pre-loaded, the navigation display engine can display the page without having to wait for the page to be delivered. Thus, the user viewing and learning experience of the interactive presentation can be preserved without unnecessary interruptions and delays.

In addition, XML, JavaScript or HTML data associated with page assets that have been delivered to the client system cache can be removed from the course structure file stored in memory. In particular, since the page assets have already been delivered to the client system, the pre-loading engine can remove their references from the course structure file to prevent the pre-loading engine from attempting to deliver those page assets to the client system again.

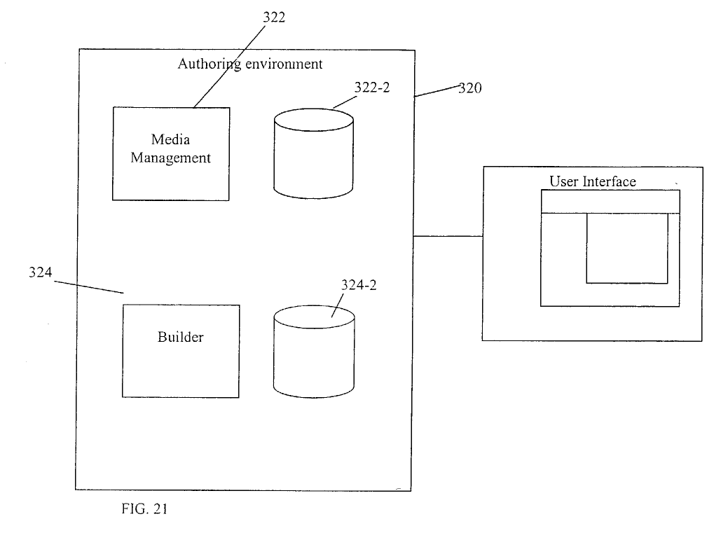

FIG. 21 is a diagram illustrating the computer system architecture for creating an interactive presentation according to an embodiment of the present invention. An authoring environment 200 allows the interactive presentation to be developed on a distributed system. The authoring environment can create an interactive presentation product, and in particular, an e-learning product. The e-learning product can be used to create an e-learning course.

The authoring environment 320 includes a media management module 322 and a builder module 324. The media management module 322 and builder module 324 include logic for authoring an interactive presentation. The modules can be applications, engines, mechanisms, or tools. The media management module can create and manage a back-end database 322-2. The builder module 324 can create and manage a back-end database 324-2. It should be understood, however, that the authoring environment 320 can have any number of modules and databases.

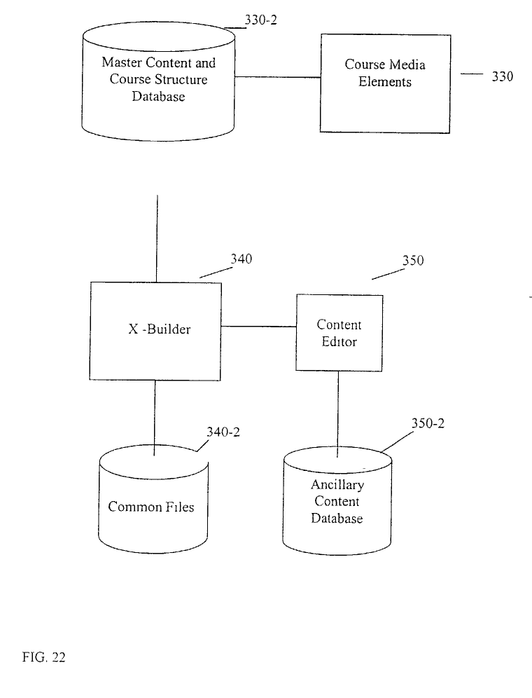

FIG. 22 is a diagram illustrating an embodiment of the authoring environment 320 of FIG. 21. The authoring environment provides a course media element (CME) application 330 and an x-builder application 340. The CME application 330 manages a master content course structure database 330-2. An x-builder application 340 manages a common files database 330-2. and an ancillary 350-2 content database.

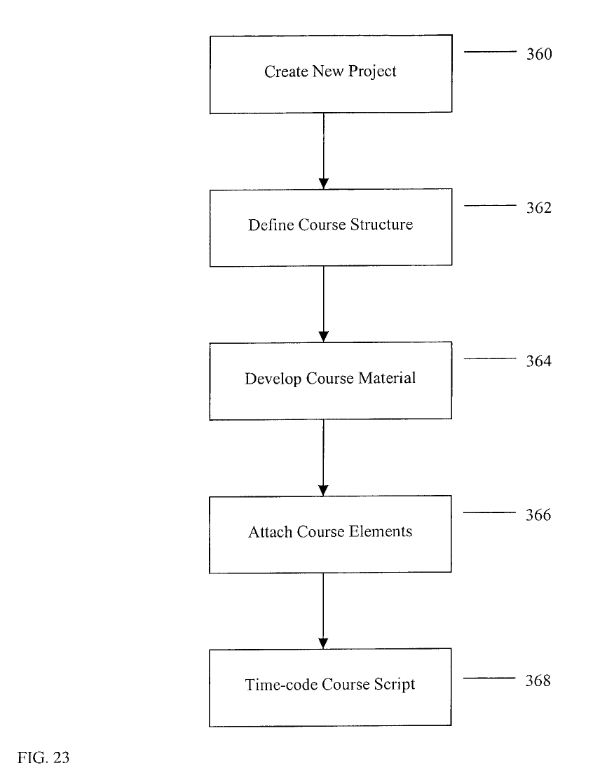

The CME application 330 develops and stores a new course project. FIG. 23 is a flow diagram describing the steps of the CME application. At step 362, the CME application 330 creates a new course project for an interactive presentation. At step 362, the CME application 330 defines a course structure for the interactive presentation. The course structure is organized in a hierarchical arrangement of course content. For example, the CME application 330 can provide a hierarchical arrangement using a table of contents structure. The table of contents structure can be organized by chapters, and the chapters can include pages.

At step 364, the CME application 330 provides course material for the course project. The CME application 330 stores individual pages with page assets in a master content library. At step 366, the CME application 330 attaches the applicable page assets to each page in the e-learning course structure. At step 368, time code information is inserted in the course script. The time code information synchronizes the media elements and the closed captioning text of the interactive presentation. For example, if the interactive presentation contains synchronized closed captioning text and animation, the closed captioning text is displayed on the user interface in synchronization with the animation. If the interactive presentation contains closed captioning text and audio, the closed captioning text is displayed in synchronization with the audio.

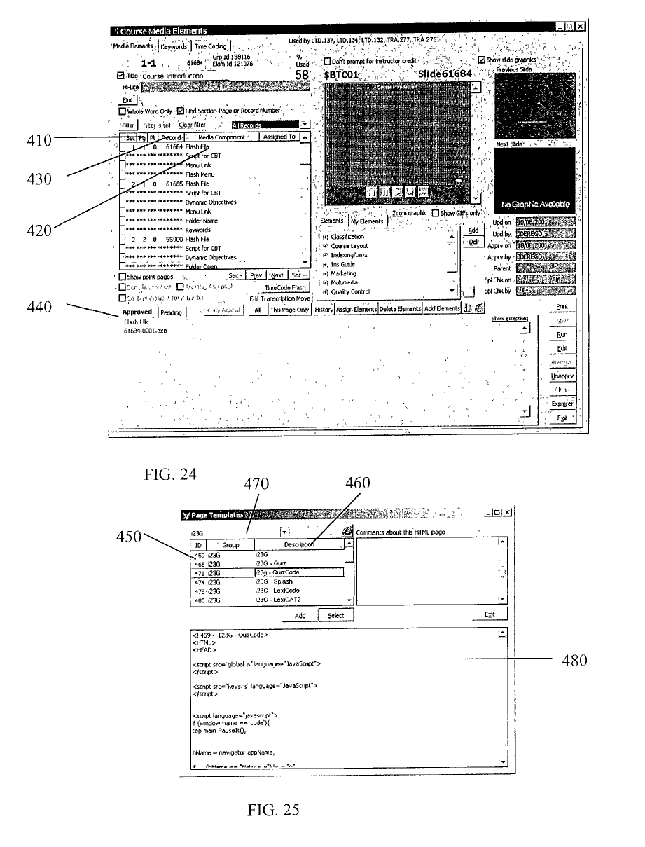

FIG. 24 is a diagram illustrating the interface of the CME application 330. The page assets of each page are displayed on the CME application 330 interface. The page column 410 indicates the number of a page in the chapter. The media component column 420 identifies the page assets that are included in a particular page. The CME application 330 creates a new record number 430 for each page asset and approves 440 the page asset.

FIG. 25 is a diagram illustrating the template manager interface of an embodiment of the CME application 330. A page template manager interface is shown. The CME application 330 can define certain actions for the x-builder application 340 to perform using the page template manager. For example, customized templates can be created that can over-ride the x-builder application's 340 default templates. Specifically, the customized templates instruct the x-builder application 340 to replace specific predefined variables in the default templates. The customized templates enable the CME application 330 to modify a template used in an interactive presentation.

A template record identification number 450 is assigned to each template. Each template can have a description 460 and can be assigned to a specific group 470 associated with a class of media elements. The template manager interface displays the code 480 for the template.

A template can be a HTML or XML document. The document can define a particular look and feel for one or more pages of the interactive presentation. The HTML file can include XML, JavaScript, and ActionScript. The look and feel can include navigation features, and presentation features, such as co-branding, colors, interface buttons, icons, toolbar arrangement, and font size, font color, and font types. For example, a template can include a style sheet that defines the features of an e-learning course.

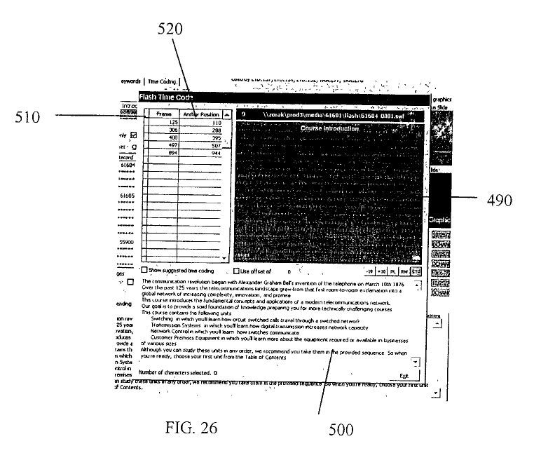

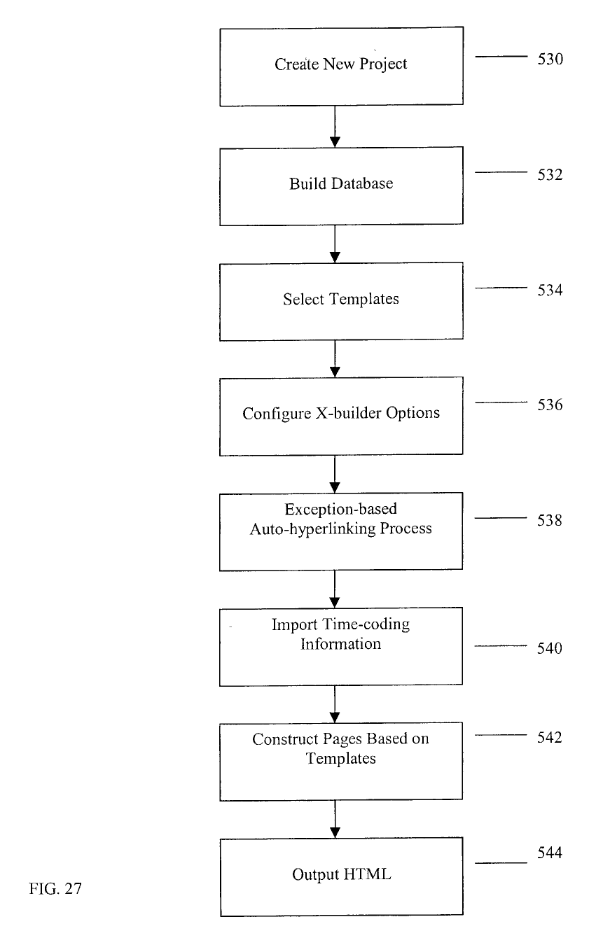

FIG. 26 is a diagram illustrating the time-coder interface of the CME application 330. The time-coder displays the animation/video region 490 and the closed captioning region 500 of the interactive presentation interface.

The time-coder can be used to synchronize particular frames of the interactive presentation that include closed captioning text. A course developer can indicate a time code for a particular frame by placing a cursor on the character position of the closed captioning text when the desired frame of the animation/video region 490 is displayed in on the time-coder interface. The time-coder time-stamps the frame by determining the frame number 510 and anchor position 520. The anchor position 520 corresponds to the cursor position on the closed captioning text. Specifically, the anchor position 520 identifies the character position of the text at the frame number 510. With the frame number 510 and the anchor position 520, the time-coder synchronizes the text 510 and animation of an interactive presentation. When the time coding information has been inserted, the time coding information for the course project can be imported into the x-builder application 350-2.

The x-builder application compiles the course project into the interactive presentation. FIG. 27 is a flow diagram describing the steps of the x-builder application. At step 530, the x-builder application 340 creates a new interactive presentation project.

At step 532, the x-builder application 340 imports the course project from the 330-2. content and course structure database 330-2. to the common files database 330-2. The x-builder application imports content from other modules in the authoring environment. For example, the x-builder application 340 can import content from the ancillary content database 350-2.

The x-builder application content editor 350 manages the content stored in the ancillary content database 350-2. The x-builder application content editor 350 is a component application of the x-builder application 340. The ancillary content database 350-2 stores reference content such as templates, glossary assets, definitions, hyperlinks to web sites, product information, and keywords. For example, the reference content can include definitions for technology keywords in an e-learning course with technology subject matter. The x-builder content editor 350 maintains the integrity of the reference content stored in the ancillary content database 350-2.

When the x-builder application 340 imports content, such as page assets from the master content and course structure database 330-2. and reference content from the ancillary content database 350-2, the x-builder application 340 creates a distinct set of content for an interactive presentation project. The x-builder application 340 imports the content and stores the content in an interactive presentation product build directory on the common files database 330-2. By importing the content to the product build directory, the x-builder application 340 can isolate the content from any changes made to master content and course structure database 330-2.

The x-builder application 340 creates a dictionary for any key terms included in the imported content from the master content and course structure database 330-2. and the ancillary content database 350-2. The dictionary can be a partial dictionary or a complete dictionary. The partial dictionary is limited to the text data terms used in the new interactive presentation project created by the x-builder. The complete dictionary includes all terms that are stored in the ancillary content database 330-2.

The ancillary content database 330-2 can include terms from other interactive presentation projects. For example, the ancillary content database 330-2 can include approved technology terms from a previous technology related e-learning course.

At step 534, the x-builder 340 selects a template suite. The x-builder application 340 can select a template suite for the interactive presentation. A template contains variables that define a particular look and feel to the pages of the interactive presentation. The template suite provides a consistent navigational elements and page properties to the interactive presentation. The x-builder 340 replaces the variables in the templates with customized template variables specified by the CME application 330.

At step 536, the x-builder application configures the build options. The x-builder can operate in several modes. Sometimes during a question and answer process, some of the build steps can be skipped to expedite build time. For example, a template can be modified and the project regenerated by doing a partial build of the interactive presentation.

At step 538, the x-builder application 340 executes the exception-based auto-hyperlinking system. The exception based auto-hyperlinking system can generate hyperlinks linking specific content in the interactive presentation project to glossary definitions or similar subject matter.

According to an embodiment of the present invention, the exception based auto-hyperlinking system automatically generates hyperlinks between keywords in text data and a technical or layman definition. A keyword includes a number of key-fields. Key-fields can include acronyms, primary expansion, secondary expansion, and common use expansion. The acronyms and expasions are ways people describe a term used in common language.

For example, a term such as “local exchange carrier” has an acronym of “LEC.” “Local exchange” is the secondary expansion of the term “local exchange carrier.” Sometimes there are one or more common use expansions.

The exception-based auto-hyperlink system uses intelligent filtering to search text data of page assets for keywords. The intelligent filtering matches words in the text data to a root-word of the keyword. The intelligent filtering can remove or add word endings in order to make a match.

The exception-based auto-hyperlink system uses logic to eliminate invalid matches through a hyperlink validation process. The hyperlink validation process provides a predefined set of rules that are designed to avoid invalid matches. For example, the hyperlink validation process determines compound words, punctuation, spacing and other characteristics to avoid making an invalid match.

The hyperlink validation process can avoid invalid matches that result from duplicate keywords. Duplicate keywords can result from the use of the same acronym in multiple e-learning topics. For example, the acronym “IP” in a computer technology context stands for information protocol, and “IP” in a law context stands for intellectual property. In one embodiment, the hyperlink validation process can determine the context of the duplicate keyword and link it to a definition based on the context that the keyword is used. In another embodiment, the hyperlink validation process can flag the duplicate keyword for human intervention.

The exception-based auto-hyperlink system can be configured to link to a first occurrence on a page, a first occurrence in each paragraph, or every occurrence of a keyword. Links generated by the exception-based auto-hyperlink system can adhere to a display protable of contentsol set by a template suite. The template suite can require a certain appearance of linked keywords.

At step 540, the x-builder application 340 imports the time coding information from the CME application. At step 542, the x-builder application 340 constructs the individual course pages based on templates. At step 544, the x-builder application 340 outputs the interactive presentation in HTML format.

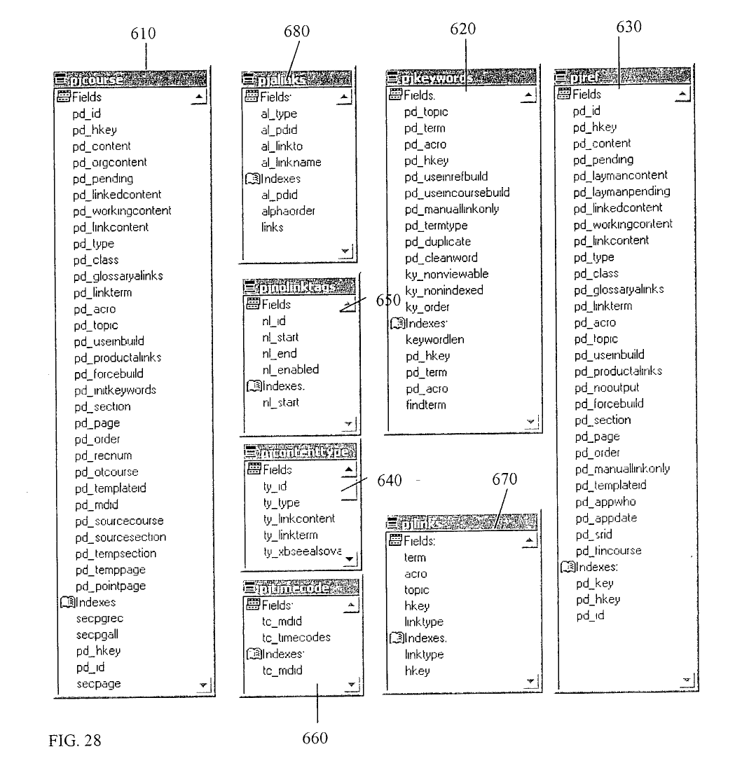

FIG. 28 is a diagram illustrating the x-builder interface displaying the organization of imported content stored in the common files database 330-2. The content stored in the common files database is organized by table. The tables within the database are linked together through the use of identification number fields. The tables organize the course content by class. Each table has a name identifier. It should be understood that the tables can have any name.

A PJCOURSE table 610 stores content for the e-learning course. This content consists primarily of the script and the graphic for any given page in the course. There is one set of records in PJCOURSE table 610 for each page in the course. Within this set of records, there is one record for each element attached to the page in CME application 330. An element can be the script for the page, the graphic that goes on the page, or any number of other elements that control the behavior of the product and the X-Builder itself.

An PJKEYWORDS table 620 stores keywords that are used by the exception-based auto-hyperlinking system. The PJKEYWORDS table 620 primarily stores keywords and classifies the keywords with respective key-fields. The key-fields are used primarily by the exception based auto-hyperlinking system.

For example, the PJKEYWORDS table 620 can have a record with the keyword “LAN” and a record with the keyword “Local Area Network”. These keywords link to the same definition in a PJREF table 630. The PJREF table 630 stores the body of the content for definitions, and for other content.

The PJKEYWORDS table 620 and the PJREF table 630 are primarily used for storing glossary-type data, but are also used to store other content that is hyperlinked into the e-learning course. For example, the tables can store information about a keyword that can be hyperlinked into an e-learning course. Whenever the keyword is mentioned in the e-learning course, a link provided to a specific page that describes that keyword.

A PJCONTENTTYPE table 640 stores information on content types that are utilized in a particular interactive presentation project. Typical content types are “Glossary”, “XYZ company product terms” and any other specific type of data that are used in the exception-based auto-hyperlinking system.

A PJNOLINKTAGS table 650 allows the x-builder application 340 to filter out certain text (stored in the PJCOURSE table) can is not intended to be hyperlinked. For example, HTML bold tags (<B></B>) can be scripted around a keyword. The bold tags can indicate a title of a paragraph. To prevent hyperlinking of paragraph titles the PJNOLINKTAGS table 650 contains a record storing HTML bold tabs (<B></B>). The exception based auto-hyperlinking system then excludes from hyperlinking any text that falls between those particular HTML tags.

A PJTIMECODE table 660 stores time coding information. The time coding information provides for a scrolling text feature in the interactive presentation.

A PJLINKS table 670 is a utility table used to store all the hyperlinks created during the build of a product. It is used only for reference content and debugging.

A PJALINKS table 680 stores data for the “see also” links in the product. For example, the term “router” can be used in the definition for local area network “LAN.” If the interactive presentation includes the term “router,” a “See Also” link can appear at the bottom of the page for “LAN”.

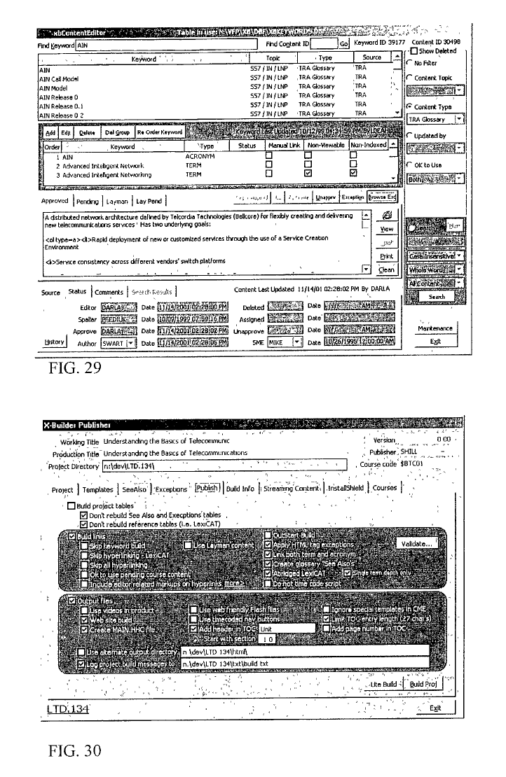

FIG. 29 is a diagram illustrating the interface of an x-builder content editor 350 interface. The x-builder content editor 350 provides the user interface for manipulating reference content stored in the ancillary content database 350-2. The x-builder content editor 350 can add, edit, delete and approve reference content that is stored in the database.

FIG. 30 is a diagram illustrating an embodiment of the x-builder application 340 interface. The x-builder application 340 interface includes a number of features for manipulating the contents of the interactive presentation project. The x-builder application 340 interface provides the user interface for manipulating specific rules and preferences used by the exception-based auto-hyperlinking system.

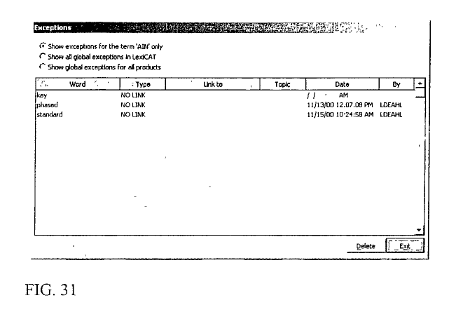

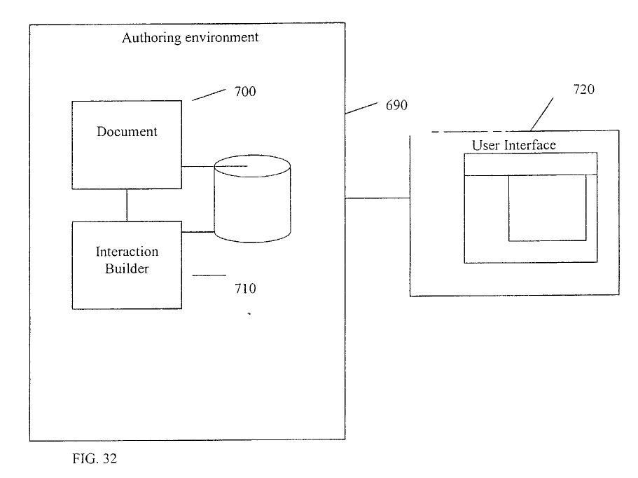

FIG. 31 is a diagram illustrating an embodiment of the x-builder application 340 interface. This embodiment displays the hyperlink exception interface. The hyperlink exception interface provides a user interface for manually eliminating invalid matches via a predefined set of rules.

FIG. 32 is a diagram illustrating computer systems architecture for creating an interactive presentation according to an embodiment of the present invention. The computer systems architecture provides an authoring environment 690 and a user interface 720. The authoring environment 690 is a document 700 and an interaction builder 710. The document 700 can be in any data processing or web authoring format such as a Microsoft Word, WordPerfect, HTML, Dreamweaver, FrontPage, ASCII, MIME, BinHex, plain text, and the like.

The document 700 can include text, media or code. For example, if the document 700 is a conventional Microsoft Word document, a user can inserts data objects such as text, images, tables, meta tags, and script, into the document. The interaction builder 710 processes all the data objects and converts the document 700 into a HTML document.

According to an aspect of the invention, the document 700 is in a Microsoft Word format, and includes headings defined by a Microsoft Word application. For example, text data can be formatted a certain way using the Microsoft Word headings. The Microsoft Word headings can define the document for the interaction builder 710. The headings in the Microsoft Word document are replaced with HTML header tags (<H1>, <H2>, <H3>, etc.). They can be replaced by the interaction builder 710 or by a convention Microsoft Word application.

Once the document is in HTML format, the HTML header tags define the structure of an XML document for the interaction builder 710. Specifically, the interaction builder 710 uses the HTML header tags as instructions as to how to build the XML document. The HTML header tags can provide time-coding information to the interaction builder 710. Specifically, the HTML header tags can instruct the interaction builder 710 as to how to synchronize the display of the XML document page assets on the user interface 720.

The HTML header tags can define a type of interactive exercise to be used, such as dichotomous, multiple choice, multiple select, matching, and ordered list. The HTML header tags can define the XML course structure file, and an XML table of contents. The HTML header tags can define new pages, such as the beginning and ending of pages. The HTML header tags can instruct the interaction builder 720 how to arrange the data objects for display on the browser user interface 720.

According to an aspect of the present invention, the interaction builder processes pseudo tags written inside the HTML header tags to determine how to build the XML document. For example, brackets such as { }, can be used in connection with the header tags to define further instruction for the interaction builder 710. Specifically, the interaction builder 710 can process such pseudo tags written inside the header tags, and further determine the properties of the page. The tags can indicate the type of data on the page and can define the beginning and ending of a page.

The interaction builder 710 processes the tags in the HTML document 700 and places the HTML document 700 into an XML document. The interaction builder 720 builds the XML data based on the HTML header tags. The XML data defines a tree structure including elements or attributes that can appear in the XML document. Specifically, the XML data can define child elements, the order of the child elements, the number of child elements, whether an element is empty or can include text, and default or fixed values for elements and attributes, or data types for elements and attributes. It is preferable that the XML document is properly structured in that the tags nest, and the document is well-formed.

The interaction builder 710 supplies an XML player with the XML data. The XML player compiles the XML data in the XML document for display in a browser on the user interface 720. In particular, a JavaScript program, that is included in the XML player, parses the XML data and displays it in a browser as HTML. The parser also utilizes parsing functions that are native to the browser.

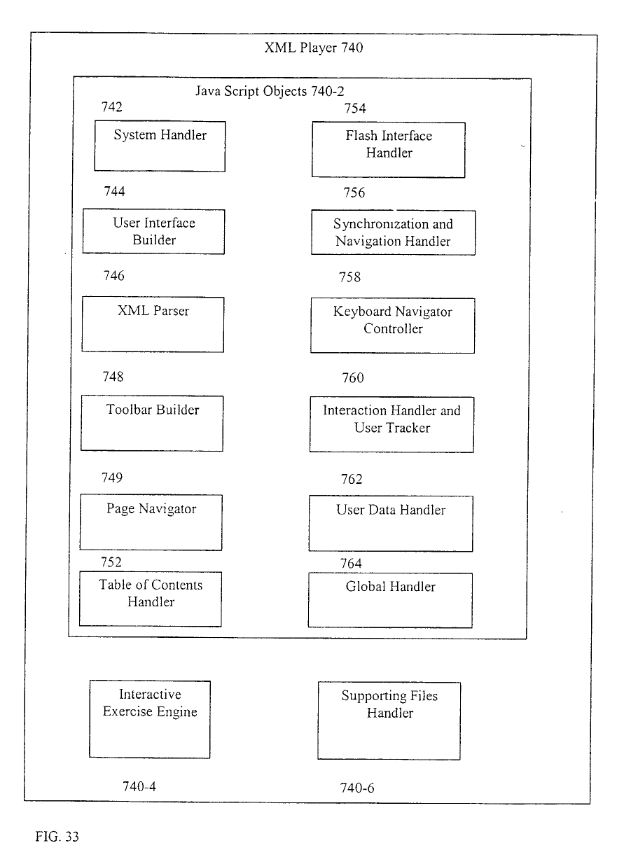

A diagram illustrating an embodiment of the XML player 740 is shown in FIG. 33. The XML player 740 is comprised of three general components: JavaScript programs 740-2, an interactive exercise engine 740-4 (written in a Flash ActionScript file) and other supporting files 740-6, such as GIFs, and HTML files.

The JavaScript programs 740-2 perform a variety of functions for the XML player 740. A system handler 742 audits the system requirements to make sure that the interactive presentation product can load on the client system 130. A user interface handler 744 builds the user interface for the interactive presentation product.

An XML parser 746 parses the XML data, such as XML data page assets, and builds an interactive presentation course structure file in memory. The XML parser proceses the XML data and renders it into a format that the browser requires. The browser includes functions that are native to the browser that can assist the XML parser 746 in rendering the XML document. The browser then interprets the rendered XML document and displays it. The XML parser 746 also handles the XML data that are processed by the hyper-download system.

A toolbar builder 748 builds the main menu for the interactive presentation product. A page navigator 750 handles page navigation through the interactive presentation. A table of contents handler 752 provides table of contents navigation based on the course structure file. A Flash interface handler 754 setups the primary Flash interface. A synchronization and navigation handler 756 loads animations with the status bar, and handles navigation of the closed captioning region of the user interface. A keyboard navigation controller 758 handles navigation events associated with keystroke interactions. An interaction handler and user tracker 760 tracks and scores user's interactions. A user data handler 762 handles user data such as cookie indicators that are stored on the client system 130 or on the server 120, such as the learning management sever. A global handler 764 handles commonly used subroutines.

In general, the XML player's 740 interactive exercise engine 740-4 generates the interactive exercises, and handles the interactions with the interactive exercises. By way of background, conventional e-learning exercises are often characterized by their rigid testing structure, and discouraging learning environment. Such e-learning exercises often fail to compensate for the fact that the instructor interactive component is lacking in the e-learning environment.

With the interactive exercise engine 740-4, the interactive presentation can provide a comfortable and encouraging learning environment for the user. For example, the interactive exercise engine 740-4 can process the user interactions with the interactive exercises, and provide feedback to the students when they answer questions associated with the exercise. The interactive exercise engine 740-4 can allow students to compare their answers with the correct answer. The interactive exercise engine 740-4 can give partial credit to answers. The interactive exercise engine 740-4 can also allow the interactive exercises to be graded at any time.

According to an aspect of the present invention, the components of the XML player are bundled together into a plugin for the browser. For example, the JavaScript programs 740-2, an interactive exercise engine 740-4 and other supporting files 740-6, such as GIFs, and HTML files, are bound together into an ActiveX DLL file, and installed into the browser. According to another aspect of the invention the XML player 740 is a Java Applet.

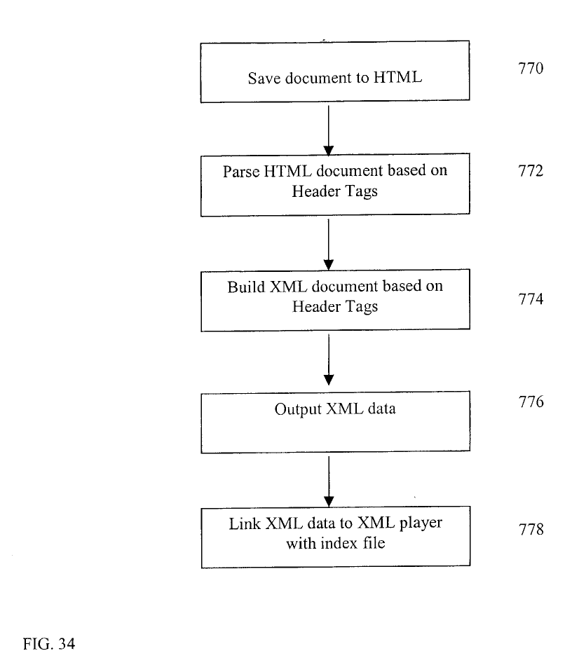

FIG. 34 is a diagram describing the steps of the authoring system of FIG. 32. At sept 770, the authoring system saves a document file to HTML format. At step 772, the HTML document is parsed based on the heading tags. At step 774, an XML document is built based on the HTML tags. At step 776, the HTML document is output as XML data. At step 778, the XML data is linked to the XML player with an index file. The index file initiates the XML player by pointing it at the XML data. This launches the interactive presentation course.

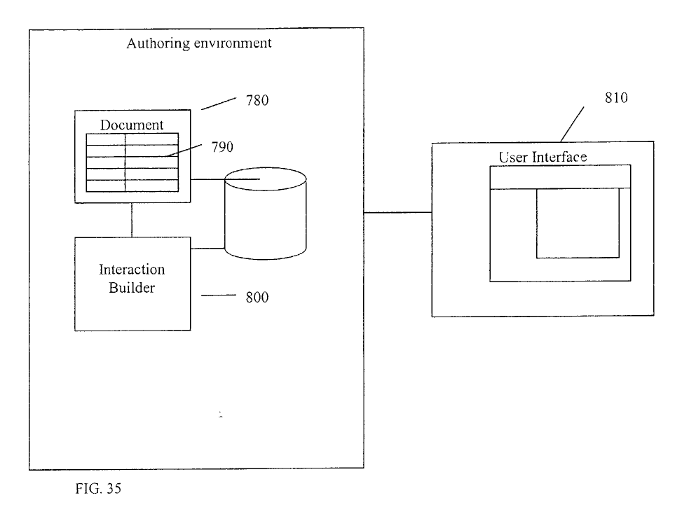

FIG. 35 is a diagram illustrating an embodiment of FIG. 32. According to an aspect of the present invention, the document 780 includes a table 790. The document 780 can be any type of word processing document that can include tables. The document 780 and its table are processed into HTML format, and then processes it into an XML document. Specifically, the table 790 defines the XML document that includes a specific interactive exercise. An interaction builder 800 can determine the type of interactive exercise defined by the table using a number of factors associated with the table 790.

The factors associated with the table 790 include: a type of data stored in the cells, specific text stored in the cells, a number of cells, rows, and columns of the table. These factors define a particular interactive exercise for the interaction builder 800 to build in an XML document. Specifically, the data stored in the cells of the table 790 can instruct the interaction builder 800 to include that data in the interactive exercise to be built by the interaction builder 720. The factors associated with the table 790 can instruct the interaction builder 800 on time-coding the animation video region, table of contents, closed captioning region, and toolbar. Specifically, factors associated with the table 790 can instruct the interaction builder 800 as to how to synchronize the assets of the XML document displayed on the user interface.

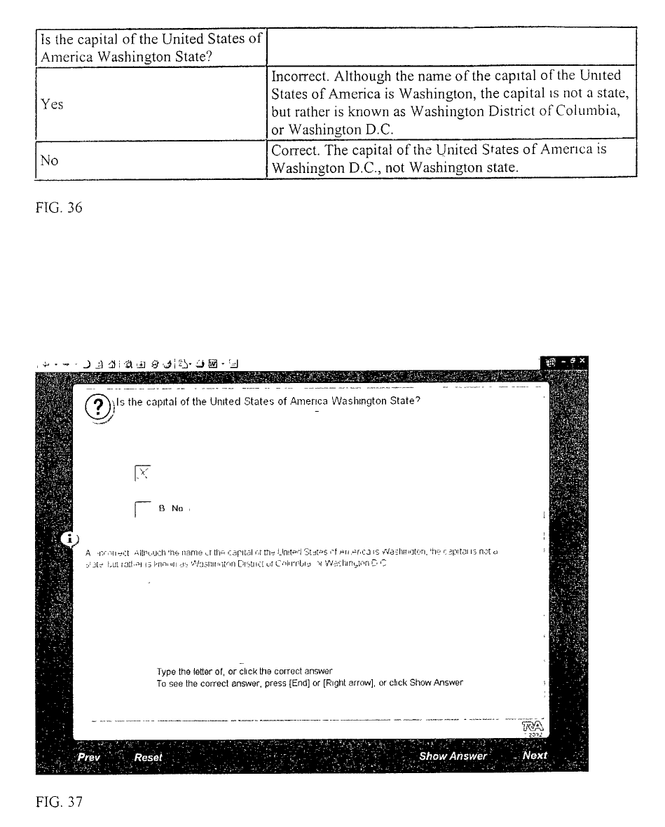

The factors associated with the table 790 can instruct the interaction builder 800 to build an exercise that is either dichotomous, multiple choice, multiple select, matching, or ordered list, and include text or media data stored in the cells of the table. For example, FIG. 36 is a diagram illustrating a table for a dichotomous exercise.

The interaction builder uses a number of factors, and indicators to determine how to place the contents of the table 790 in an interactive exercise. According to one aspect of the invention, the interaction builder 800 can determine that the first column of the table 790 is associated with the question and that the second column is associated with the answer. According to another aspect of the invention, the interaction builder 800 determines a type of interaction based on the tabs and spaces associated with the table 790. According to another aspect of the invention, the interaction builder 800 can process the table 790 and search for specific terms associated with exercises, such as “correct,” “incorrect,” “yes,” and “no.” According to another aspect of the invention, the interaction builder 800 can search for punctuation, such as question marks to determine which cell includes a question for the exercise.

Once the interaction builder processes the HTML table and determines the type of interactive exercise, the interaction engine stores the text data of the table cells as variables into a string. The HTML document is then placed into an XML document, and can be displayed by the XML player.

When the XML document is displayed on the user interface by the XML player, the interaction engine generates an interactive exercise that integrates the text data stored as variables in the string. Specifically, the text data originally in the table 790 is displayed as part of the interactive exercise. FIG. 37 is a diagram illustrating the table data of FIG. 36 in a dichotomous interactive exercise displayed on the animation-video region of the user interface. The text data in the cells of the table of FIG. 36 are integrated into the dichotomous interactive exercise.

According to an embodiment of FIG. 35, the HTML table 790 cells can include media elements, such as graphics and animations, that can be integrated into the interactive exercise. The interaction builder 800 uses the factors associated with the table 790 to determine the type of interactive exercise. Then the interaction engine stores the media elements into a JavaScript array, and the interaction builder 800 processes the HTML document into XML format.

It will be apparent to those of ordinary skill in the art that methods involved in computerized learning system can be embodied in a computer program product that includes a computer usable medium. For example, such a computer usable medium can include a readable memory device, such as a hard drive device, a CD-ROM, a DVD-ROM, or a computer diskette, having computer readable program code segments stored thereon. The computer readable medium can also include a communications or transmission medium, such as a bus or a communications link, either optical, wired, or wireless, having program code segments carried thereon as digital or analog data signals.

It will further be apparent to those of ordinary skill in the art that, as used herein, “interactive presentation” can be broadly construed to mean any electronic simulation with text, audio, animation, video or media asset thereof directly or indirectly connected or connectable in any known or later-developed manner to a device such as a computer.

While this invention has been particularly shown and described with references to certain embodiments thereof, it will be understood by those skilled in the art that various changes in form and details can be made therein without departing from the spirit and scope of the invention as defined by the appended claims.

What is claimed is:

1. A method for developing an interactive presentation in extensible markup language (XML), the method comprising:
building an extensible markup language (XML) document based on header tags of a hypertext markup language (HTML) document.

2. The method of claim 1 further comprises:
processing the HTML document based on the header tags.

3. The method of claim 1 wherein the header tags, further comprises:
defining a layout of page assets associated with the XML document; and
defining time-coding data for displaying the page assets of the XML document in synchronization on a user interface.

4. The method of claim 1 includes at least one of:
defining a structure of the XML document based on pseudo tags associated with the header tags;
determining a beginning and ending of pages based on the header tags;
determining an arrangement of data objects for display on a user interface based on the header tags;
defining synchronization data for displaying media objects on a user interface based on the header tags; and
defining a type of interactive exercise to be displayed in the XML document based on the header tags.

5. The method of claim 4 wherein the type of interactive exercise is at least one of: a dichotomous exercise, a multiple choice exercise, a multiple select exercise, and an ordered list exercise.

6. The method of claim 4 wherein the XML document is one of: a course structure file, and a table of contents.

7. The method of claim 1 wherein the XML document is part of an interaction presentation.

8. The method of claim 1 wherein the HTML document includes a table defining a type of interactive exercise.

9. The method of claim 8 wherein the type of interactive exercise is indicated by a number of cells, a number of rows, and a number of columns associated with the table.

10. The method of claim 1 further comprises:
converting a word processing document having heading styles into the HTML document, for each heading style:
converting the heading style into a HTML header tag.

11. The method of claim 1 further comprises:
determining a type of interactive exercise based on factors associated with the data objects, wherein the factors including:
determining a type of data stored in the HTML document;
determining specific text stored in the HTML document; and
determining a number of tabs and spaces associated with the HTML document.

12. The method of claim 11 further comprises:
storing data objects associated with the HTML document as variables into a string that is associated with the determined interactive exercise.

13. The method of claim 12, wherein the data objects associated with the HTML document are at least one of: a text data object, a graphical data object, and an animated data object.

14. The method of claim 11 further comprises:
rendering the XML document into a format that a browser user interface requires;
integrating the data objects stored in the string with the interactive exercise of the XML document;
displaying the rendered XML document with the interactive exercise on the browser user interface; and
displaying the interactive exercise of the XML document with the data objects.

15. The method of claim 1 further comprises:
linking the XML document to an XML player; and
rendering the XML document into a format that a browser user interface requires with the XML player.

16. The method of claim 15 wherein the XML player includes JavaScript programs, an interactive exercise engine and supporting files.

17. A method for developing an interactive presentation in extensible markup language (XML), the method comprising:
building an extensible markup language (XML) document based on a table stored in a hypertext markup language (HTML) document.

18. The method of claim 17 wherein the table, further comprises:
determining contents of the XML document based on factors associated with the table, the factors including at least one of:
a number of cells in the table;
a number of columns in the table;
a number of rows in the table;
text punctuation stored in a cell of the table; and
text data associated with interactive exercises.

19. The method of claim 18 wherein the text data associated with interactive exercises is a term, which is one of: correct, incorrect, yes and no.

20. The method of claim 17 wherein the table indicates a type of interactive exercise, the type of exercise is at least one of: a dichotomous exercise, a multiple choice exercise, a multiple select exercise, and an ordered list exercise.

21. The method of claim 17 wherein the table, further comprises:
determining a layout of page assets associated with the XML document; and
determining time-coding data for displaying the page assets of the XML document in synchronization on a user interface.

22. The method of claim 17 includes at least one of:
defining a structure of the XML document based on the table;
defining a structure of the XML document based on header tags associated with the header tags;
determining a beginning and ending of pages based on the table;
determining an arrangement of data objects for display on a user interface based on the table;
defining synchronization data for displaying media objects on a user interface based on the table; and
defining a type of interactive exercise to be displayed in the XML document based on the table.

23. The method of claim 22 wherein the XML document is one of: a course structure file, and a table of contents.

24. The method of claim 17 wherein the XML document is part of an interaction presentation.

25. The method of claim 17 further comprises:
determining a type of interactive exercise based on factors associated with the data objects stored in cells of the table, wherein the factors include:
determining a type of data stored in the table;
determining specific text stored in the table; and
determining a number of tabs and spaces associated with the table.

26. The method of claim 25 further comprises:
storing data objects associated with the table into a string as variables associated with the determined interactive exercise.

27. The method of claim 25, wherein the data objects associated with the table are at least one of: text data object, graphical data object, and animated data object.

28. The method of claim 25 further comprises:
rendering the XML document into a format that a browser user interface requires;
integrating the data objects stored in the string with the interactive exercise of the XML document;
displaying the rendered XML document with the interactive exercise on the browser user interface; and
displaying the interactive exercise of the XML document with the data objects.

29. The method of claim 17 further comprises:
linking the XML document to an XML player; and
rendering the XML document into a format that a browser user interface requires with the XML player.

30. The method of claim 29 wherein the XML player includes JavaScript programs, an interactive exercise engine and supporting files.

31. A system for developing an interactive presentation in extensible markup language (XML), the system comprising:
a builder to generate an extensible markup language (XML) document based on header tags of a hypertext markup language (HTML) document.

32. The system of claim 31 wherein the header tags of the HTML document define the structure of the XML document including:
a layout of page assets associated with the XML document; and
time-coding data for displaying the page assets of the XML document in synchronization on a user interface.

33. The system of claim 31 wherein the builder determines an arrangement for the XML document including:
a structure of the XML document based on pseudo tags associated with the header tags;
a beginning and ending of pages based on the header tags;
an arrangement of data objects for display on a user interface based on the header tags;
synchronization data for displaying media objects on a user interface based on the header tags; and
a type of interactive exercise to be displayed in the XML document based on the header tags.

34. The system of claim 31 wherein the determined structure includes:
a type interactive exercise associated with the header tags of the HTML document, the type of interactive exercise is at least one of: a dichotomous exercise, a multiple choice exercise, a multiple select exercise, a matching exercise, and an ordered list exercise.

35. The system of claim 34 wherein the type of interactive exercise is at least one of: a dichotomous exercise, a multiple choice exercise, a multiple select exercise, and an ordered list exercise.

36. The system of claim 34 wherein the XML document is at least one of: a course structure file, and a table of contents.

37. The system of claim 31 wherein the XML document is part of an interaction presentation.

38. The system of claim 31 wherein the HTML document includes a table defining a type of interactive exercise.

39. The system of claim 38 wherein the type of exercise is indicated by a number of cells, a number of rows, and a number of columns associated with the table.

40. The system of claim 31 wherein the builder converts a word processing document having heading styles into the HTML document having header tags.

41. The system of claim 31 wherein the builder determines a type of interactive exercise based on factors associated with the data objects, wherein the factors include:
a type of data stored in the HTML document;
text stored in the HTML document; and
a number of tabs and spaces in with the HTML document.

42. The system of claim 41 wherein the builder stores data objects associated with the HTML document into a string as variables, the string is in connection with the determined interactive exercise, for each determined interactive exercise:
an interactive exercise engine processing the string.

43. The system of claim 42, wherein the data objects associated with the HTML document are at least one of: text data object, graphical data object, and animated data object.

44. The system of claim 42 further comprises:
an XML player for rendering the XML document with the interactive exercise in a browser user interface, wherein the XML player interfaces with the interactive exercise engine for integrating the variables stored in the string into the interactive exercise.

45. The system of claim 31 wherein the builder links the XML document to an XML player; and a browser in connection with the XML player displays the XML document on a user interface.

46. The system of claim 45 wherein the XML player includes JavaScript programs, an interactive exercise engine and supporting files.

47. A system for developing an interactive presentation in extensible markup language (XML), the system comprising:
a means for generating an extensible markup language (XML) document based on header tags stored in a hypertext markup language (HTML) document.

48. The system of claim 47 further comprising:
a means for accepting a variable stored in the HTML document; and
a means for integrating the variable into an interactive presentation.

49. The system of claim 47 further comprising:
a means to render the XML document in a browser user interface.

50. A system for developing an interactive presentation in extensible markup language (XML), the system comprising:
a means for generating an extensible markup language (XML) document based on a table stored in a hypertext markup language (HTML) document.

51. The system of claim 50 further comprising:
a means for accepting a variable stored in the table; and
a means for integrating the variable into an interactive presentation.

52. The system of claim 47 further comprising:
a means to render the XML document in a browser user interface.

53. A system for developing an electronic learning presentation that utilizes an extensible markup language (XML) player, the system comprising:
a player for rendering extensible markup language (XML) data in a browser user interface, wherein data objects associated with the XML data are processed with an interactive exercise engine for generating interactive exercises based on the XML data objects.
